(19) United States
(12) Patent Application Publication
(10) Pub. No.: US 2026/0216848 A1
(43) Pub. Date: Jul. 30, 2026

(54) ANGLE IMPACT TOOL

(71) Applicant: MAKITA CORPORATION, Anjo-shi (JP)

(72) Inventors: Ding ZHAO, Anjo-shi (JP); Daiki IMAIDA, Anjo-shi (JP)

(73) Assignee: MAKITA CORPORATION, Anjo-shi (JP)

(21) Appl. No.: 19/451,249

(22) Filed: Jan. 16, 2026

(30) Foreign Application Priority Data
Jan. 27, 2025 (JP) 2025-011695

(51) Int. Cl. B25B 21/02; B25B 21/00; B25F 5/00; B25F 5/02

(52) U.S. Cl. CPC B25B 21/02; B25F 5/001; B25F 5/02; B25B 21/002

(57) ABSTRACT

An angle impact tool includes: a motor including a rotor rotatable about a first rotation axis extending in a front-rear direction; and an impact mechanism converting a continuous torque input from the motor into consecutive rotational impacts capable of generating tightening torque of 275 Nm or more to a tightening member. The impact mechanism includes: a spindle extending along a second rotation axis extending in an up-down direction; an anvil arranged below the spindle and including, at a lower end thereof, a tip tool holding portion having a width across flats of ⅜ inches or more and ⅞ inches or less in a cross section orthogonal to the second rotation axis; a hammer rotatable about the second rotation axis while moving with respect to the spindle in the up-down direction and impacts the anvil in a rotation direction; and a spring that biases the hammer toward the anvil.

### CROSS-REFERENCE TO RELATED APPLICATION(S)

The present application claims priority to and incorporates by reference the entire contents of Japanese Patent Application No. 2025-011695 filed in Japan on Jan. 27, 2025.

### TECHNICAL FIELD

The techniques disclosed in the present teachings relate to an angle impact tool.

### BACKGROUND

There is a known pistol-type power impact tool (for example, Japanese Patent No. 5844970). There is also an angle impact tool that enables tightening work in a narrow place not allowing insertion of a distal end of a pistol-type power impact tool. The angle impact tool has a rod shape with a bent distal end, and thus can perform tightening work by inserting the distal end into a narrow work place.

An angle impact tool used for work in a narrow place tends to have lower tightening torque than other types of impact tools due to size restrictions and the like. There is a need for high tightening torque in the angle impact tools.

One non-limiting object of the present teachings is to improve tightening torque of an angle impact tool.

### SUMMARY OF THE INVENTION

In one non-limiting aspect of the present teachings, an angle impact tool may include: a housing including a grip portion extending in a front-rear direction, a motor housing portion arranged forward of the grip portion, and a battery holding portion arranged rearward of the grip portion and detachably holding a battery pack; a motor arranged inside the motor housing portion and including a rotor that is rotatable about a first rotation axis extending in the front-rear direction by electric power supplied from the battery pack; and an impact mechanism that converts a continuous torque input from the motor into consecutive rotational impacts capable of generating tightening torque of 275 Nm or more to a tightening member. The impact mechanism may include: a spindle extending along a second rotation axis extending in an up-down direction; an anvil arranged below the spindle and including, at a lower end thereof, a tip tool holding portion having a width across flats of ⅜ inches or more and ⅞ inches or less in a cross section orthogonal to the second rotation axis; a hammer that is rotatable about the second rotation axis while moving with respect to the spindle in the up-down direction and impacts the anvil in a rotation direction; and a spring that biases the hammer toward the anvil.

According to the present teachings, tightening torque of the angle impact tool can be improved.

### BRIEF DESCRIPTION OF THE DRAWINGS

FIG. 1 is a perspective view illustrating an angle impact tool according to an embodiment;

FIG. 2 is a side view illustrating the angle impact tool according to the embodiment;

FIG. 3 is a longitudinal sectional view illustrating the angle impact tool according to the embodiment;

FIG. 4 is a longitudinal sectional view illustrating a middle portion of the angle impact tool according to the embodiment;

FIG. 5 is a longitudinal sectional view illustrating a front portion of the angle impact tool according to the embodiment;

FIG. 6 is a longitudinal sectional view illustrating a motor according to the embodiment;

FIG. 7 is a longitudinal sectional view illustrating an impact mechanism according to the embodiment;

FIG. 8 is a side view illustrating a spindle according to the embodiment;

FIG. 9 is a perspective view illustrating a hammer according to the embodiment;

FIG. 10 is a perspective view illustrating an anvil according to the embodiment; and

FIG. 11 is a sectional view illustrating a tip tool holding portion according to the embodiment.

### DETAILED DESCRIPTION OF PREFERRED EMBODIMENTS

In one or more embodiments, an angle impact tool may include: a housing including a grip portion extending in a front-rear direction, a motor housing portion arranged forward of the grip portion, and a battery holding portion arranged rearward of the grip portion and detachably holding a battery pack; a motor arranged inside the motor housing portion and including a rotor that is rotatable about a first rotation axis extending in the front-rear direction by electric power supplied from the battery pack; and an impact mechanism that converts a continuous torque input from the motor into consecutive rotational impacts capable of generating tightening torque of 275 Nm or more to a tightening member. The impact mechanism may include: a spindle extending along a second rotation axis extending in an up-down direction; an anvil arranged below the spindle and including, at a lower end thereof, a tip tool holding portion having a width across flats of ⅜ inches or more and ⅞ inches or less in a cross section orthogonal to the second rotation axis; a hammer that is rotatable about the second rotation axis while moving with respect to the spindle in the up-down direction and impacts the anvil in a rotation direction; and a spring that biases the hammer toward the anvil.

In the above configuration, in the angle impact tool, which has a structure including: the grip portion extending in the front-rear direction; the motor housing portion arranged forward of the grip portion; and the battery holding portion arranged rearward of the grip portion and detachably holding the battery pack, and to which a tip tool of ⅜ inches or more and ⅞ inches or less is attached, tightening torque of 275 Nm or more to a tightening member can be generated. Thus, the tightening torque of the angle impact tool can be improved.

In the one or more embodiments, weight of the hammer may be 135 g or more and 600 g or less.

In the above configuration, impact force of the hammer can be improved, and high tightening torque can be achieved even in the angle impact tool.

In the one or more embodiments, the number of impacts per rotation of the hammer may be larger than 1.

In the above configuration, the number of impacts of the hammer is increased, and the high tightening torque can be achieved in a short time even in the angle impact tool.

In the one or more embodiments, a moment of inertia of the hammer may be 40 kg·mm² or more and 500 kg·mm² or less.

In the above configuration, the impact force of the hammer can be improved, and the high tightening torque can be achieved even in the angle impact tool.

In the one or more embodiments, a diameter of the hammer may be 43 mm or more and 80 mm or less. A total length of the hammer may be 26 mm or more and 45 mm or less.

In the above configuration, in the angle impact tool, it is possible to prevent an increase in a size of the impact mechanism, and convenience in work in a narrow place is improved.

In the one or more embodiments, the impact mechanism may include a ball that is arranged between the spindle and the hammer and that moves the hammer in the rotation direction and the up-down direction as the spindle rotates. An upward/downward moving distance of the hammer with respect to the spindle may be 8 mm or more and 16 mm or less.

In the above configuration, even in a case where the high tightening torque is realized, it is possible to prevent an increase in the upward/downward moving distance of the hammer. As a result, since an size in the up-down direction of the impact mechanism is shortened, convenience in the work in the narrow place is improved.

In the one or more embodiments, the impact mechanism may be capable of generating the tightening torque of 300 Nm or more.

In the above configuration, even in the angle impact tool, the higher tightening torque is achieved.

In the one or more embodiments, the impact mechanism may be capable of generating nut busting torque of 450 Nm or more. Note that the nut busting torque is torque applied to the tightening member when the tightening member in a tightened state is loosened.

In the above configuration, it is possible to achieve the high nut busting torque required when loosening the tightening member firmly fixed by rust or the like.

In the one or more embodiments, weight of the anvil may be 55 g or more and 250 g or less.

In the above configuration, the high tightening torque can be achieved even in the angle impact tool.

In the one or more embodiments, a moment of inertia of the anvil may be 3.60 kg·mm² or more and 30.00 kg·mm² or less.

In the above configuration, the high tightening torque can be achieved even in the angle impact tool.

In the one or more embodiments, the angle impact tool may include a case arranged forward of the motor housing portion and including an impact mechanism housing portion that houses the impact mechanism while protruding the tip tool holding portion downward. A distance in the up-down direction between the lower end of the anvil and an upper surface of the impact mechanism housing portion may be 85 mm or less.

In the above configuration, since the size in the up-down direction of the portion that performs the tightening work is shortened, convenience in the work in the narrow place is improved.

In the one or more embodiments, a distance in the front-rear direction between a central axis of the anvil and a front end surface of the impact mechanism housing portion may be 30 mm or less.

In the above configuration, the distance in the front-rear direction from the front end surface of the impact mechanism housing portion is shortened. This improves convenience of when the angle impact tool is inserted into the narrow place for the work.

In the one or more embodiments, the rotor may include a rotor shaft portion extending in the front-rear direction. The angle impact tool may further include: a bevel gear provided on the rotor shaft portion; and a speed reduction mechanism that is connected to the bevel gear, reduces a rotation of the bevel gear, and transmits the rotation to the spindle.

In the above configuration, the rotation of the motor is reduced by the speed reduction mechanism, whereby the torque necessary for rotating the spindle can be acquired without an increase in the size of the motor.

In the one or more embodiments, the speed reduction mechanism may include: a first speed reduction portion that is connected to the bevel gear and that rotates to reduce the rotation of the bevel gear; and a second speed reduction portion that reduces the rotation of the first speed reduction portion and transmits the rotation to the spindle.

In the above configuration, a multi-stage speed reduction can be performed in a process of performing rotation transmission to the spindle. Thus, a high reduction ratio can be achieved.

In the one or more embodiments, the battery holding portion may include, on a lower surface of the battery holding portion, a battery mounting portion onto which the battery pack is mountable.

In the above configuration, since the battery pack is mounted on the lower surface of the battery holding portion, even a large battery pack can be mounted without an increase in the size of the housing.

In the one or more embodiments, the angle impact tool may include a trigger lever provided on a lower surface of the grip portion and operated to start the motor.

In the above configuration, operability of the angle impact tool is improved.

In the one or more embodiments, the angle impact tool may include: a motor including a rotor that is rotatable about the first rotation axis extending in the front-rear direction and a stator to rotate the rotor; a motor housing portion that houses the motor; a grip portion arranged rearward of the motor housing portion; a battery holding portion that is arranged rearward of the grip portion and detachably holds a battery pack for supplying electric power to the motor; a spindle that is rotated by the rotor and extends along the second rotation axis extending in the up-down direction; a hammer that is rotated by the spindle; and an anvil that is arranged below the hammer and includes, at a lower end thereof, a tip tool holding portion having a width across flats of ⅜ inches or more and ⅞ inches or less in a cross section orthogonal to the second rotation axis. The maximum tightening torque of the anvil may be 275 Nm or more.

In the above configuration, in the angle impact tool, which has the structure including: the motor housing portion; the grip portion arranged rearward of the motor housing portion; and the battery holding portion arranged rearward of the grip portion and detachably holding the battery pack, and to which the tip tool of ⅜ inches or more and ⅞ inches or less is attached, the maximum tightening torque of 275 Nm or more can be generated. Thus, the tightening torque of the angle impact tool can be improved.

Hereinafter, embodiments will be described with reference to the drawings. In the embodiments, the positional relationship of each component will be described using terms of left, right, front, rear, up, and down. These terms indicate relative positions or directions with respect to the center of an angle impact tool.

### First Embodiment

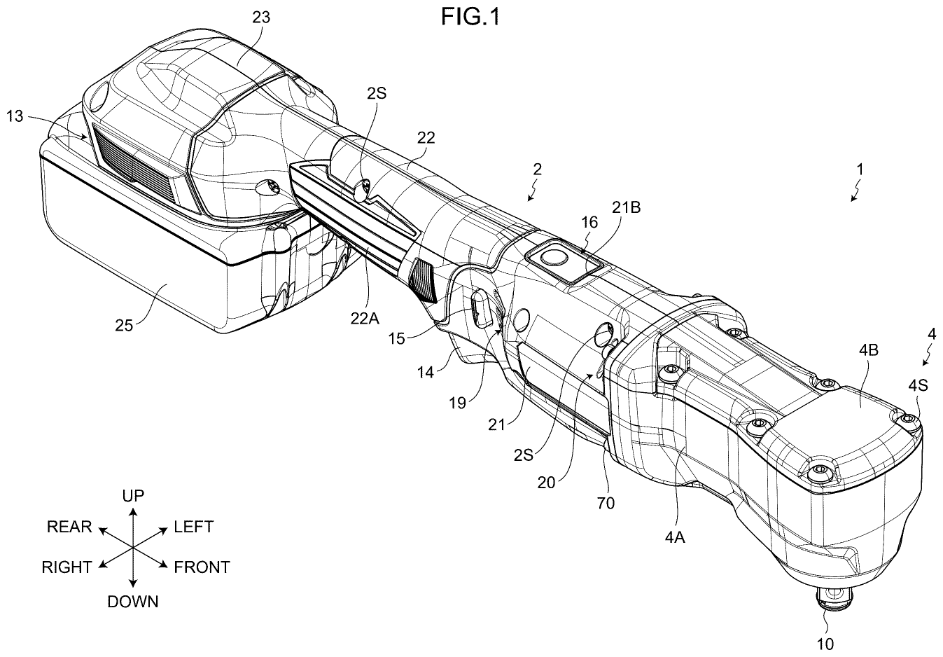

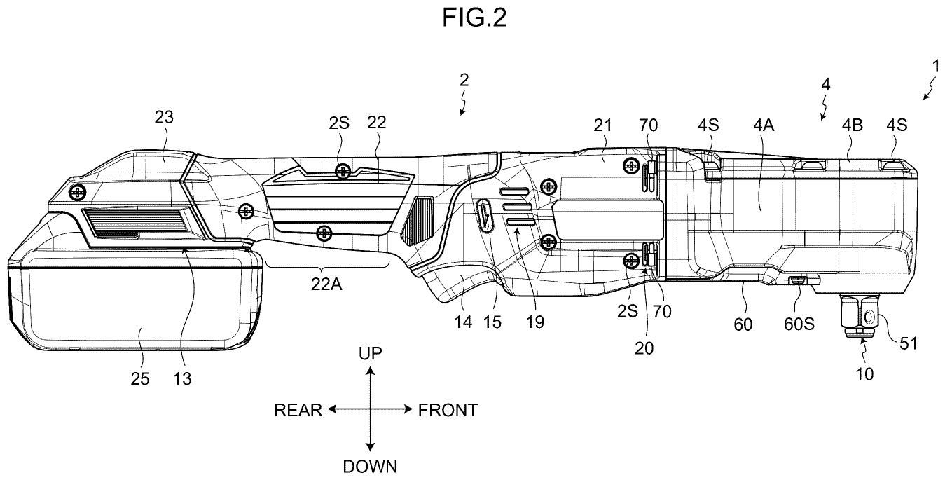

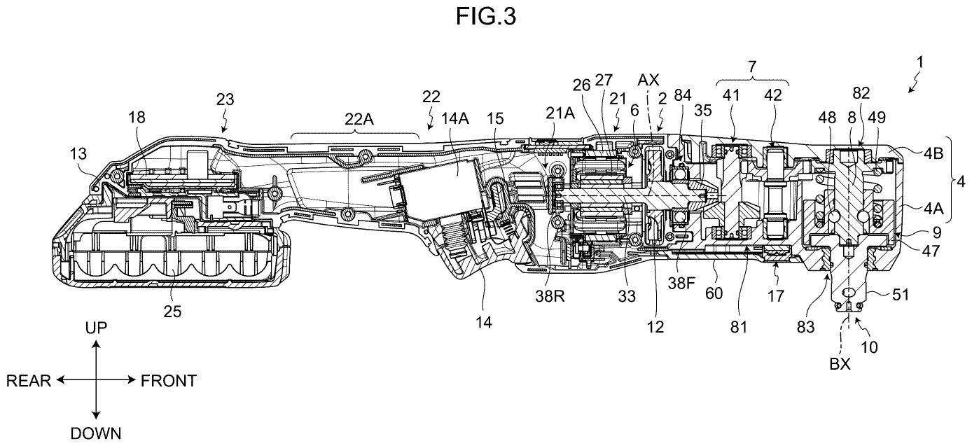

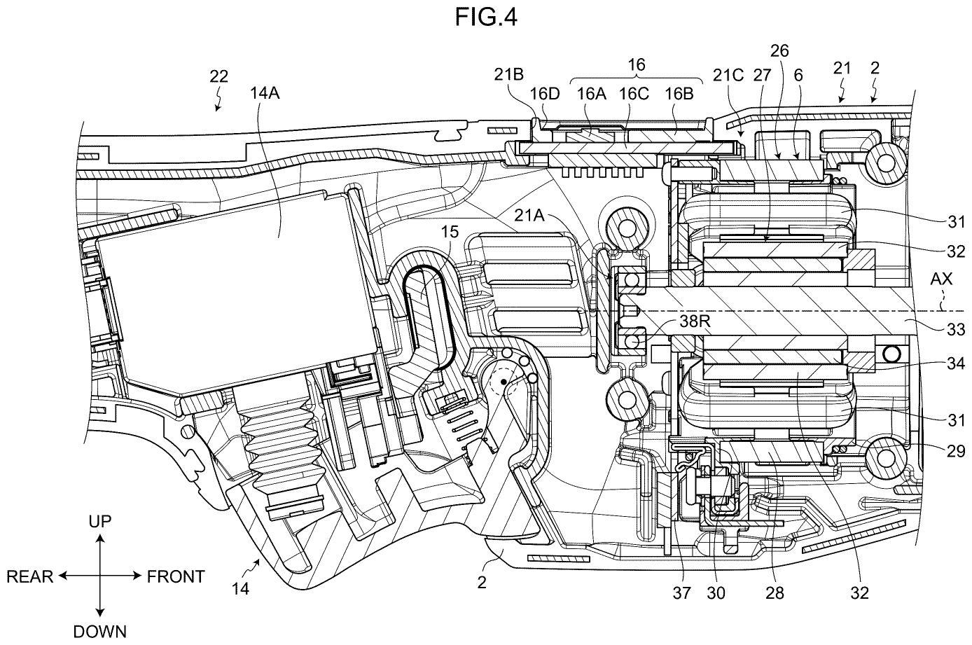

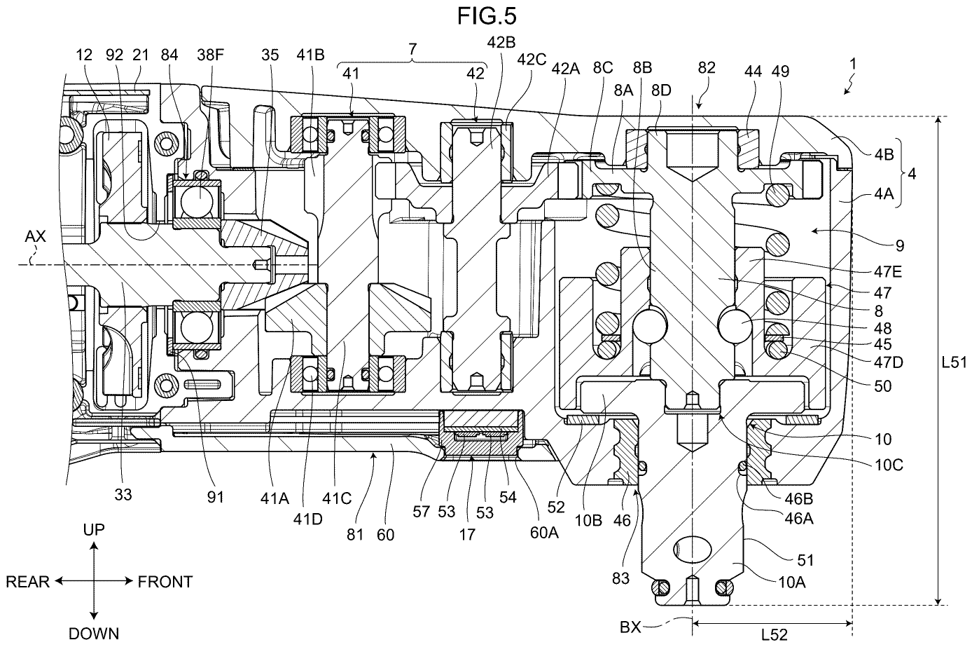

FIG. 1 is a perspective view illustrating an angle impact tool 1 according to an embodiment. FIG. 2 is a side view illustrating the angle impact tool 1 according to the embodiment. FIG. 3 is a longitudinal sectional view illustrating the angle impact tool 1 according to the embodiment. FIG. 4 is a longitudinal sectional view illustrating a middle portion of the angle impact tool 1 according to the embodiment. FIG. 5 is a longitudinal sectional view illustrating a front portion of the angle impact tool 1 according to the embodiment.

In the embodiment, the angle impact tool 1 is a power tool having a motor 6 being an electric motor, as a power source. The direction parallel to a first rotation axis AX of the motor 6 is appropriately referred to as an axial direction, the direction around the first rotation axis AX is appropriately referred to as a circumferential direction or a rotation direction, and a radiation direction of the first rotation axis AX is appropriately referred to as a radial direction. In the radial direction, a position close to or a direction approaching the first rotation axis AX is appropriately referred to as “radially inward” or an inner side in the radial direction, and a position far from or a direction away from the first rotation axis AX is appropriately referred to as “radially outward” or an outer side in the radial direction. In the embodiment, the first rotation axis AX extends in the front-rear direction. One side in the axial direction is a front side (forward), and the other side in the axial direction is a rear side (rearward).

In the embodiment, the angle impact tool 1 is an angle impact wrench. The angle impact tool 1 includes a housing 2, a case 4, a motor 6, a speed reduction mechanism 7, an impact mechanism 9 including a spindle 8 and an anvil 10, a fan 12, a trigger lever 14, a forward/reverse switching lever 15, an operation panel 16, a light unit 17, and a controller 18.

The housing 2 is made of a synthetic resin. The housing 2 includes a pair of left and right half-split housings. The pair of half-split housings is fixed by a plurality of screws 2S.

The housing 2 includes a motor housing portion 21, a grip portion 22, and a battery holding portion 23.

The motor housing portion 21 constitutes a front portion of the housing 2. The motor housing portion 21 is arranged forward of the grip portion 22. The motor housing portion 21 has a tubular shape. The motor housing portion 21 houses the motor 6. The motor housing portion 21 houses the motor 6, the fan 12, and a bearing 38R. The operation panel 16 is provided on an upper side of the motor housing portion 21.

The grip portion 22 extends in the front-rear direction. The grip portion 22 extends rearward from the motor housing portion 21. The grip portion 22 is gripped by an operator. The grip portion 22 includes the trigger lever 14 and a grip 22A. The trigger lever 14 is provided on the front side of the grip portion 22. The trigger lever 14 is provided on the lower surface of the grip portion 22. The grip 22A is provided rearward of the trigger lever 14. The grip 22A has a columnar shape. The grip 22A is a portion of the grip 22 that is gripped by an operator.

The battery holding portion 23 is arranged rearward of the grip portion 22. The battery holding portion 23 is connected to a rear end portion of the grip portion 22. The battery holding portion 23 detachably holds the battery pack 25. The battery holding portion 23 includes, on a lower surface of the battery holding portion 23, a battery mounting portion 13 onto which the battery pack 25 can be mounted. The battery pack 25 is mounted onto the battery mounting portion 13 provided in the lower surface of the battery holding portion 23. The battery holding portion 23 houses the controller 18.

The motor housing portion 21 has intake ports 19 and exhaust ports 20. The intake ports 19 and the exhaust ports 20 are provided in right and left side surfaces of the motor housing portion 21. The air in external space of the housing 2 flows into the internal space of the housing 2 via the intake ports 19. The air in the internal space of the housing 2 flows out to the external space of the housing 2 via the exhaust ports 20.

The housing 2 and the case 4 are aligned in the front-rear direction. The case 4 is arranged forward of the motor housing portion 21. The motor housing portion 21 and the case 4 are connected to each other in the front-rear direction. The front portion of the housing 2 and a rear portion of the case 4 are connected to each other. The housing 2 and the case 4 are fixed by screws 70. The case 4 is connected to a front portion of the motor housing portion 21. The motor housing portion 21 is fixed to the rear portion of the case 4.

The case 4 houses a bevel gear 35 that is a pinion gear. The case 4 houses the speed reduction mechanism 7. The case 4 houses the impact mechanism 9. The impact mechanism 9 includes the spindle 8, the anvil 10, a hammer 47, and a spring 49. The case 4 houses the spindle 8. The case 4 houses the hammer 47. The case 4 houses a part of the anvil 10. The case 4 houses the spring 49. The case 4 is made of metal. In the embodiment, the case 4 is made of aluminum.

The case 4 has a hollow box shaped. The case 4 includes a case body 4A and a lid portion 4B. The case body 4A has a hollow box shape, and a rear surface and an upper surface thereof are opened. The rear surface of the case body 4A is connected to the motor housing portion 21 of the housing 2 and is covered with the motor housing portion 21. The upper surface of the case body 4A is covered with the lid portion 4B. The lid portion 4B is provided on the upper surface of the case body 4A from a front end to the front side of a rear end, and is fixed to the case body 4A by screws 4S. The bevel gear 35, the speed reduction mechanism 7, and the impact mechanism 9 are assembled to the case 4 through the upper surface opening of the case body 4A. In this state, the lid portion 4B is mounted to the case body 4A to allow these portions to be housed in the case 4.

The case 4 has a front surface, right and left side surfaces, and a lower surface, which are configured with the case body 4A. The light unit 17 and a light cover 60 are arranged on the lower surface of the case 4. An anvil insertion hole 83 is formed near a front end portion of the lower surface of the case 4. The anvil insertion hole 83 communicates with the inside of the case 4. The anvil 10 passes through the anvil insertion hole 83. The anvil 10 protrudes downward from the inside of the case 4 to a lower side of the case 4 through the anvil insertion hole 83.

The case 4 holds a bearing 38F that supports the rotor 27 of the motor 6 in a rotatable manner. The speed reduction mechanism 7 is arranged forward of the bearing 38F. The impact mechanism 9 including the spindle 8 is arranged forward of the speed reduction mechanism 7. The anvil 10 is arranged below the spindle 8.

The motor 6 is a power source of the angle impact tool 1. The motor 6 generates rotational force. The motor 6 is an electric motor. The motor 6 is an inner rotor-type brushless motor. The motor 6 is housed in the motor housing portion 21 of the housing 2. The motor 6 is arranged inside the motor housing portion 21.

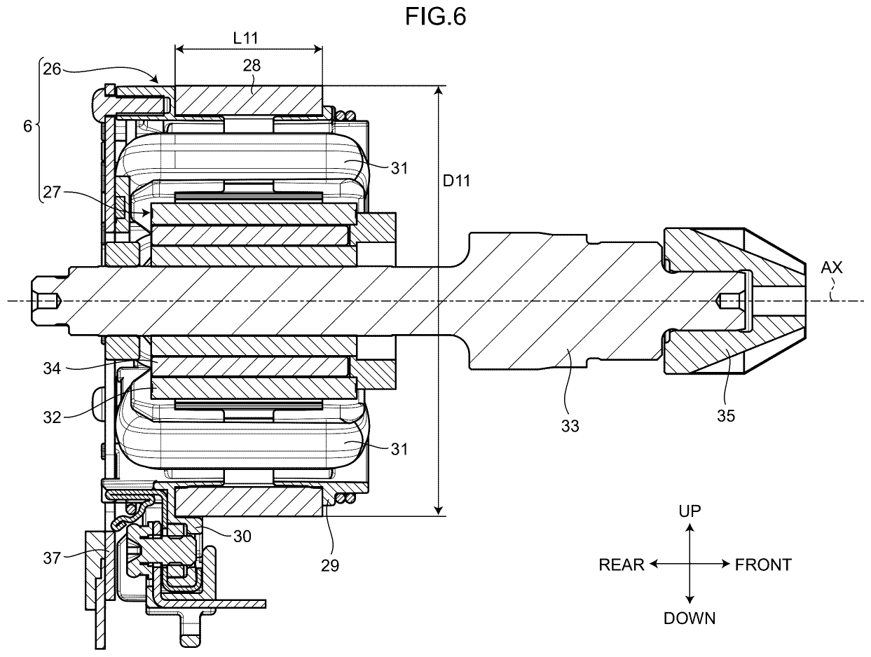

FIG. 6 is a longitudinal sectional view illustrating the motor 6 according to the embodiment. As illustrated in FIG. 4 and FIG. 6, the motor 6 includes a stator 26 and a rotor 27 rotatable with respect to the stator 26. The stator 26 is supported by the motor housing portion 21. At least a part of the rotor 27 is located inside the stator 26. The rotor 27 rotates with respect to the stator 26. The rotor 27 rotates about the first rotation axis AX extending in the front-rear direction by the electric power supplied from the battery pack 25.

The stator 26 includes a stator core 28, a front insulator 29, a rear insulator 30, and coils 31.

The stator core 28 is arranged outside the rotor 27 in the radial direction. The stator core 28 includes a plurality of steel sheets stacked in the axial direction. The steel sheets are metal plates containing iron as a main component. The stator core 28 has a tubular shape. The stator core 28 includes a plurality of teeth respectively supporting the coils 31.

The front insulator 29 is provided at the front portion of the stator core 28. The rear insulator 30 is provided at the rear portion of the stator core 28. Each of the front insulator 29 and the rear insulator 30 is an electric insulating member made of a synthetic resin. The front insulator 29 is arranged so as to cover a part of surfaces of the teeth. The rear insulator 30 is arranged so as to cover a part of the surfaces of the teeth.

The coils 31 are mounted on the stator core 28 via the front insulator 29 and the rear insulator 30. The coils 31 are wound on the respective teeth of the stator core 28 via the front insulator 29 and the rear insulator 30. The coils 31 and the stator core 28 are electrically insulated from each other by the front insulator 29 and the rear insulator 30.

The rotor 27 rotates about the first rotation axis AX. The rotor 27 includes a rotor core portion 32, a rotor shaft portion 33, and a rotor magnet 34.

Each of the rotor core portion 32 and the rotor shaft portion 33 is made of steel. In the embodiment, the rotor core portion 32 and the rotor shaft portion 33 are separate bodies. The rotor core portion 32 and the rotor shaft portion 33 may be integrally formed. The rotor shaft portion 33 extends in the front-rear direction. A central axis of the rotor shaft portion 33 is the first rotation axis AX. The front portion of the rotor shaft portion 33 protrudes forward from a front end surface of the rotor core portion 32. A rear portion of the rotor shaft portion 33 protrudes rearward from a rear end surface of the rotor core portion 32.

The rotor magnet 34 is fixed to the rotor core portion 32. The rotor magnet 34 extends to the front-rear direction so as to penetrate the rotor core portion 32.

A sensor board 37 is attached to the rear insulator 30. The sensor board 37 includes an annular circuit board and a magnetic sensor supported by the circuit board. At least a part of the sensor board 37 faces the rotor magnet 34. The magnetic sensor detects the position of the rotor 27 in the rotation direction by detecting magnetic force of the rotor magnet 34.

As illustrated in FIG. 4 and FIG. 5, bearings (38F and 38R) are located on the front side and the rear side with respect to the rotor 27, respectively. The bearings (38F and 38R) support the rotor 27 in a rotatable manner. The rear portion of the rotor shaft portion 33 is rotatably supported by the bearing 38R. The front portion of the rotor shaft portion 33 is rotatably supported by the bearing 38F. The bearing 38R is held by the housing 2. As illustrated in FIG. 4, the bearing 38R is housed in a rear holding portion 21A having a recessed shape and provided in the motor housing portion 21. As illustrated in FIG. 5, the bearing 38F is housed in a housing recess portion 84 provided in the rear portion of the case 4. The housing recess portion 84 is recessed forward from a rear surface of the case 4. A rear surface of the bearing 38F is supported by a front wall portion 92 of the motor housing portion 21 via an intermediate support member 91. The intermediate support member 91 is a ring-shaped or C-shaped plate member. The bearing 38F is sandwiched between the rear surface of the case 4 (inner bottom surface of the housing recess portion 84) and a front surface of the housing 2 in the front-rear direction via the intermediate support member 91. A front end portion of the rotor shaft portion 33 is arranged in the internal space of the case 4 through an opening in the front surface of the motor housing portion 21 and an opening in the rear portion of the case 4.

In one example, the bearing 38F has a diameter (outer diameter) of 28.0 mm. In one example, the bearing 38F has a length (front-rear size) of 8.0 mm.

As illustrated in FIG. 5, the bevel gear 35 is provided on the rotor shaft portion 33. The bevel gear 35 is arranged at the front end portion of the rotor shaft portion 33. The bevel gear 35 is a pinion gear that rotates integrally with the rotor 27. The bevel gear 35 is connected to at least a part of the speed reduction mechanism 7. The rotor shaft portion 33 is coupled to the speed reduction mechanism 7 via the bevel gear 35.

In one example, the motor 6 has a nominal diameter of 30 mm or more. In another example, the nominal diameter of the motor 6 is 43 mm or more. In yet another example, the nominal diameter of the motor 6 is 50 mm or more. As illustrated in FIG. 6, the nominal diameter of the motor 6 is specifically an outer diameter D11 of the stator core 28. In one example, a stacking thickness of the stator 26 is 10 mm or more. In another example, the stacking thickness of the stator 26 is 15 mm or more. In yet another example, the stacking thickness of the stator 26 is 20 mm or more. Specifically, the stacking thickness of the stator 26 is a length L11 along the first rotation axis AX of the stator core 28. For example, the motor 6 is a BL44-15 motor, that is, a brushless motor in which a nominal diameter is 44 mm and a stacking thickness of the stator 26 is 15 mm. In addition, the motor 6 may be a BL52-15 motor. The motor 6 may be a BL52-24 motor. A combination of the nominal diameter and the stacking thickness of the motor 6 may be a combination different from the above specific examples, and shall include a configuration within a range of ±2 mm for each of the nominal diameter and the stacking thickness.

As illustrated in FIG. 5, the speed reduction mechanism 7 is connected to the bevel gear 35 that is the pinion gear. The speed reduction mechanism 7 reduces the rotation of the bevel gear 35 and transmits the rotation to the spindle 8. As a result, the speed reduction mechanism 7 transmits the rotational force of the motor 6 to the spindle 8 and the anvil 10.

The speed reduction mechanism 7 is housed in the case 4. The case 4 includes a speed reduction mechanism housing portion 81 that houses the speed reduction mechanism 7. The speed reduction mechanism housing portion 81 constitutes the rear portion of the case 4. The speed reduction mechanism housing portion 81 houses at least a part of the bevel gear 35 and the speed reduction mechanism 7 therein. The speed reduction mechanism housing portion 81 is connected to the rear surface of the case 4. The speed reduction mechanism housing portion 81 is opened on the rear surface of the case 4. The front end portion of the rotor shaft portion 33, on which the bevel gear 35 is provided, is inserted into the inside of the speed reduction mechanism housing portion 81 from the opening in the rear surface of the case 4.

The speed reduction mechanism 7 includes a plurality of gears. The speed reduction mechanism 7 is arranged forward of the motor 6. The speed reduction mechanism 7 is arranged forward of the bearing 38F. The speed reduction mechanism 7 couples the rotor shaft portion 33 and the spindle 8 to each other. The gears of the speed reduction mechanism 7 are driven by the rotor 27. The speed reduction mechanism 7 transmits the rotation of the rotor 27 to the spindle 8. The speed reduction mechanism 7 rotates the spindle 8 at a rotational speed lower than a rotational speed of the rotor shaft portion 33 (that is, the bevel gear 35).

The speed reduction mechanism 7 includes a multiple-stage speed reduction portions. The speed reduction mechanism 7 includes a first speed reduction portion 41 and a second speed reduction portion 42. The first speed reduction portion 41 is connected to the bevel gear 35 that is the pinion gear, and rotates to reduce the rotation of the bevel gear 35. The second speed reduction portion 42 reduces the rotation of the first speed reduction portion 41 and transmits the rotation to the spindle 8.

The first speed reduction portion 41 includes a driven gear 41A, a first intermediate gear 41B, and a first intermediate shaft 41C. The first intermediate shaft 41C extends in a direction intersecting the first rotation axis AX. A first intermediate shaft 41C extends in the up-down direction orthogonal to the first rotation axis AX and rotates about the central axis in the up-down direction. Ends of the first intermediate shaft 41C are rotatably supported by intermediate bearings 41D, respectively. The intermediate bearings 41D are held by the case 4. The intermediate bearings 41D are ball bearings. The driven gear 41A and the first intermediate gear 41B are fixed to the first intermediate shaft 41C. In the present embodiment, the first intermediate gear 41B and the first intermediate shaft 41C are integrated to each other. The first intermediate gear 41B and the first intermediate shaft 41C may be separate bodies. The driven gear 41A is attached to a lower portion of the first intermediate shaft 41C, and the first intermediate gear 41B is attached to an upper portion of the first intermediate shaft 41C. The driven gear 41A, the first intermediate gear 41B, and the first intermediate shaft 41C rotate integrally. The driven gear 41A is a bevel gear that meshes with the bevel gear 35 that is the pinion gear. The first intermediate gear 41B is a spur gear. The first intermediate gear 41B meshes with a second intermediate gear 42A of the second speed reduction portion 42.

The second speed reduction portion 42 is arranged forward of the first speed reduction portion 41. The second speed reduction portion 42 includes the second intermediate gear 42A and a second intermediate shaft 42B. The second intermediate shaft 42B extends in the direction intersecting the first rotation axis AX. A second intermediate shaft 42B extends in the up-down direction orthogonal to the first rotation axis AX and rotates about the central axis in the up-down direction. The first intermediate shaft 41C and the second intermediate shaft 42B are parallel to each other. Ends of the second intermediate shaft 42B are rotatably supported by intermediate bearings 42C, respectively. The intermediate bearings 42C are held by the case 4. The intermediate bearings 42C are plain bearings. The second intermediate gear 42A is fixed to the second intermediate shaft 42B. The second intermediate gear 42A is attached to an upper portion of the second intermediate shaft 42B. The second intermediate gear 42A and the second intermediate shaft 42B rotate integrally. The second intermediate gear 42A is a spur gear. The second intermediate gear 42A meshes with the first intermediate gear 41B. The second intermediate gear 42A rotates to reduce the rotation of the first intermediate gear 41B. The second intermediate gear 42A meshes with a spindle gear 8C of the spindle 8. The spindle gear 8C rotates integrally with the spindle 8. The spindle gear 8C is a spur gear.

When the rotor shaft portion 33 rotates by the driving of the motor 6, the bevel gear 35 rotates, and then, the bevel gear 35 rotates the driven gear 41A. Due to the rotation of the driven gear 41A, the first intermediate shaft 41C rotates at a rotational speed lower than the rotational speed of the rotor shaft portion 33. When the first intermediate shaft 41C rotates, the first intermediate gear 41B rotates, and then, the first intermediate gear 41B rotates the second intermediate gear 42A. The second intermediate gear 42A rotates at a rotational speed lower than the rotational speed of the first intermediate shaft 41C. The second intermediate gear 42A rotates the spindle gear 8C. The spindle gear 8C rotates at a rotational speed lower than the rotational speed of the second intermediate gear 42A. As the spindle gear 8C rotates, the spindle 8 rotates. The spindle 8 rotates at a rotational speed lower than the rotational speed of the rotor shaft portion 33.

The speed reduction mechanism 7 has a predetermined reduction ratio between the bevel gear 35 and the spindle 8. The reduction ratio of the speed reduction mechanism 7 is, for example, 8 or more and 11 or less. In one example, the reduction ratio of the speed reduction mechanism 7 is 8.10 or more. In another example, the reduction ratio of the speed reduction mechanism 7 is 8.20 or more. In yet another example, the reduction ratio of the speed reduction mechanism 7 is 8.30 or more. In addition, in one example, the reduction ratio of the speed reduction mechanism 7 is 10.80 or less. In another example, the reduction ratio of the speed reduction mechanism 7 is 10.60 or less. In yet another example, the reduction ratio of the speed reduction mechanism 7 is 10.40 or less.

The impact mechanism 9 is driven by the motor 6. The rotational force of the motor 6 is transmitted to the impact mechanism 9 via the speed reduction mechanism 7. The impact mechanism 9 gives impacts on the anvil 10 in the rotation direction based on rotational force of the spindle 8 rotated by the motor 6.

As illustrated in FIG. 5, the impact mechanism 9 includes the spindle 8, the hammer 47, balls 48, and the spring 49.

The impact mechanism 9 is housed in the case 4. The case 4 includes an impact mechanism housing portion 82 that houses the impact mechanism 9. The impact mechanism housing portion 82 constitutes a front portion of the case 4. The impact mechanism housing portion 82 houses at least a part of the spindle 8, the hammer 47, the balls 48, the spring 49, and a part of the anvil 10 therein. The impact mechanism housing portion 82 is arranged forward of the speed reduction mechanism housing portion 81. The anvil insertion hole 83 is formed in a lower surface of the impact mechanism housing portion 82. The lower end of the anvil 10 passes through the anvil insertion hole 83 and protrudes downward from the lower surface of the impact mechanism housing portion 82. As a result, the tip tool holding portion 51 arranged at the lower end of the anvil 10 is arranged below the impact mechanism housing portion 82.

Details of the impact mechanism 9 will be described later.

The fan 12 is rotated by the rotational force of the motor 6. As illustrated in FIG. 3, the fan 12 is arranged forward of the stator 26 of the motor 6. The fan 12 generates an airflow for cooling the motor 6. The fan 12 is fixed to at least a part of the rotor 27. The fan 12 is fixed to the front portion of the rotor shaft portion 33. The fan 12 is arranged between the bearing 38F and the stator 26. The fan 12 is rotated by the rotation of the rotor 27. When the rotor shaft portion 33 rotates, the fan 12 rotates together with the rotor shaft portion 33. When the fan 12 rotates, the air in the external space of the housing 2 flows into the internal space of the housing 2 via the intake ports 19. The air flowing into the internal space of the housing 2 flows through the internal space of the housing 2 to cool the motor 6. When the fan 12 rotates, the air flowing through the internal space of the housing 2 flows out to the external space of the housing 2 via the exhaust ports 20.

As illustrated in FIG. 4, the operation panel 16 is provided in the motor housing portion 21. The operation panel 16 is exposed to the outside through a panel opening 21B formed in an upper surface of the motor housing portion 21. The operation panel 16 is arranged near a boundary with the grip portion 22 at the rear portion of the motor housing portion 21. The operation panel 16 is arranged forward of the trigger lever 14.

The operation panel 16 has a plate shape. The operation panel 16 includes an operation button 16A, an indicator display 16B, and a switch board 16C. The operation button 16A and the indicator display 16B are fixed to the switch board 16C via a bracket 16D having a frame shape. The bracket 16D is fitted into the panel opening 21B. The switch board 16C has a flat plate shape. The switch board 16C is a circuit board on which the operation button 16A and the indicator display 16B are provided. The switch board 16C is connected to the controller 18 by wiring. The motor housing portion 21 includes a holding groove 21C that supports an outer periphery of the switch board 16C at a position immediately below the panel opening 21B. The bracket 16D is fitted into the panel opening 21B, whereby the operation panel 16 is positioned in the front-rear direction and the right-left direction. The outer periphery of the switch board 16C is fitted into the holding groove 21C, whereby the operation panel 16 is positioned in the up-down direction. The switch board 16C is arranged on the upper portion of the motor housing portion 21 and is along the upper surface of the motor housing portion 21. The operation panel 16 outputs a signal corresponding to an input of the operation button 16A to the controller 18, and displays information by the indicator display 16B according to the signal from the controller 18.

When the operator operates the operation button 16A, the controller 18 switches the operation mode of the motor 6. The indicator display 16B has a light emitting element. The light emitting element is, for example, an LED light emitting element. The indicator display 16B displays the operation mode of the motor 6 by changing lighting patterns of the plurality of light emitting elements. Examples of the operation modes include: operation modes of strong, medium, and weak operation modes indicating three stages of the rotation speed setting of the motor 6; a mode of stopping the motor 6 based on the detection of a start of impacting by the impact mechanism 9; and a mode of switching the motor 6 to stop or low speed rotation based on the detection of rotation of a nut when loosening the nut.

As illustrated in FIG. 3, the battery mounting portion 13 is arranged in a lower portion of the battery holding portion 23. The battery pack 25 is mounted onto the battery mounting portion 13. The battery pack 25 is detachable from the battery mounting portion 13. The battery mounting portion 13 holds the battery pack 25 slidably in the front-rear direction. When the battery pack 25 is slid forward from the rear of the battery mounting portion 13 and reaches an engagement position, the battery mounting portion 13 is engaged with an engagement hook of the battery pack 25 to regulate a rearward sliding movement of the battery pack 25. The battery pack 25 has a release button for vertically advancing and retracting the engagement hook. When the release button is pressed, the engagement hook is retreated downward to release the engagement state with the battery mounting portion 13. This enables attachment and detachment of the battery pack 25. The battery pack 25 is held facing downward from the lower surface of the battery holding portion 23 by the battery mounting portion 13.

The battery pack 25 functions as a power supply of the angle impact tool 1. The battery pack 25 includes a secondary battery. In the embodiment, the battery pack 25 includes a rechargeable lithium-ion battery. By being mounted onto the battery mounting portion 13, the battery pack 25 can supply electric power to the angle impact tool 1. The motor 6 and the light unit 17 are each driven based on the electric power supplied from the battery pack 25.

The rated voltage of the battery pack 25 is 14.4 V or more. The rated voltage of the battery pack 25 may be 18 V, 36 V, or 72 V.

The controller 18 operates based on the electric power supplied from the battery pack 25. The controller 18 is connected to the motor 6, the switch board 16C, and the trigger lever 14 via wires. The controller 18 is connected to the battery pack 25 via a wire. The wires pass through the inside of the grip portion 22.

The controller 18 outputs a control signal of controlling the motor 6. The controller 18 includes a circuit board on which a plurality of electronic components are mounted. Examples of the electronic parts mounted on the circuit board include a processor such as a central processing unit (CPU), a nonvolatile memory such as a read only memory (ROM) or a storage, a volatile memory such as a random access memory (RAN), a field effect transistor (FET), and a resistor. The controller 18 sets the operation mode of the angle impact tool 1 based on the operation on the operation panel 16. Setting parameters of the operation mode of the angle impact tool 1 include a current threshold of the motor 6, an on/off control condition, and the like. The controller 18 outputs a signal of displaying the setting state of the operation mode to the operation panel 16.

The controller 18 is arranged rearward of the operation panel 16. The controller 18 is arranged rearward of the trigger lever 14. The controller 18 is arranged in the battery holding portion 23. The controller 18 is arranged above the battery mounting portion 13. The controller 18 extends in the front-rear direction and the right-left direction. The battery holding portion 23 has a dome-shaped outer shape forming a housing space for the controller 18.

The trigger lever 14 is provided on the lower surface of the grip portion 22. The trigger lever 14 is provided on the front end of the grip portion 22. The trigger lever 14 is provided so as to protrude downward from the lower surface of the grip portion 22. The trigger lever 14 is operated by an operator to start the motor 6. A switch body 14A is arranged on an upper portion of the trigger lever 14. The switch body 14A is arranged inside the grip portion 22. The switch body 14A is operated when the trigger lever 14 is operated. A trigger signal is generated when the switch body 14A is operated. The controller 18 performs switching between driving and stopping of the motor 6 based on the trigger signal.

The forward/reverse switching lever 15 is provided in the grip portion 22. The forward/reverse switching lever 15 is arranged at a position above the trigger lever 14 on right and left side surfaces of the grip portion 22. The forward/reverse switching lever 15 is operated by an operator. When the forward/reverse switching lever 15 is operated, the rotation direction of the motor 6 is switched from one of a forward rotation direction or a reverse rotation direction to the other. A rotation direction of the spindle 8 is switched by switching of the rotation direction of the motor 6.

The light unit 17 emits illumination light. The light unit 17 illuminates the anvil 10 and the surroundings of the anvil 10 with the illumination light. The light unit 17 includes one or a plurality of light emitters 53. The light unit 17 includes a chip-on-board light emitting diode (COB LED).

The light unit 17 is arranged on the lower surface of the case 4. The light unit 17 is arranged around the anvil 10. In the example of FIG. 5, the light unit 17 includes two light emitters 53. The light emitters 53 are held by the case 4. The light emitters 53 are held on the lower surface of the case 4. The plurality of light emitters 53 is provided around the anvil 10. The two light emitters 53 are arranged on the rear side of the anvil 10.

The light unit 17 includes: a substrate 54 on which the plurality of light emitters 53; and an optical member 57. The light emitters 53 are arranged with a gap therebetween in the front-rear direction on a lower surface of the substrate 54. Electric power supplied to electrodes is supplied to the light emitters 53 via the substrate 54. The light emitters 53 emit light based on the electric power supplied from the battery pack 25. The light unit 17 and the controller 18 are connected to each other via a lead wire (s).

The light unit 17 includes an optical member 57 that covers the plurality of light emitters 53. At least a part of the optical member 57 is arranged in a light emission direction (that is, the lower side) of the plurality of light emitters 53. The optical member 57 faces the plurality of light emitters 53. The optical member 57 transmits at least a part of the light emitted from the light unit 17. The optical member 57 has a light transmittance of, for example, 40% or more and 70% or less. The optical member 57 diffuses the light of the plurality of light emitters 53.

A part of the optical member 57 is covered with the light cover 60 from below. The light cover 60 has an opening portion 60A through which a part of the optical member 57 is exposed without being covered. In the optical member 57, a portion covering the plurality of light emitters 53 is exposed through the opening portion 60A. Light from the plurality of light emitters 53 is transmitted through the optical member 57, passes through the opening portion 60A of the light cover 60, and is emitted toward the lower side of the case 4. The light cover 60 holds the light unit 17 on the lower surface of the case 4. The light unit 17 is held between the lower surface of the case 4 and the light cover 60.

As illustrated in FIG. 2, the light cover 60 is fixed to the lower surface of the case 4 by screws 60S, and the screws 60S tighten the light cover 60 toward the lower surface of the case 4. The light cover 60 extends rearward toward the motor housing portion 21 along the lower surface of the case 4. A rear end of the light cover 60 is engaged with the motor housing portion 21. The light cover 60 covers the lead wires extending to the light unit 17 along the lower surface of the case 4.

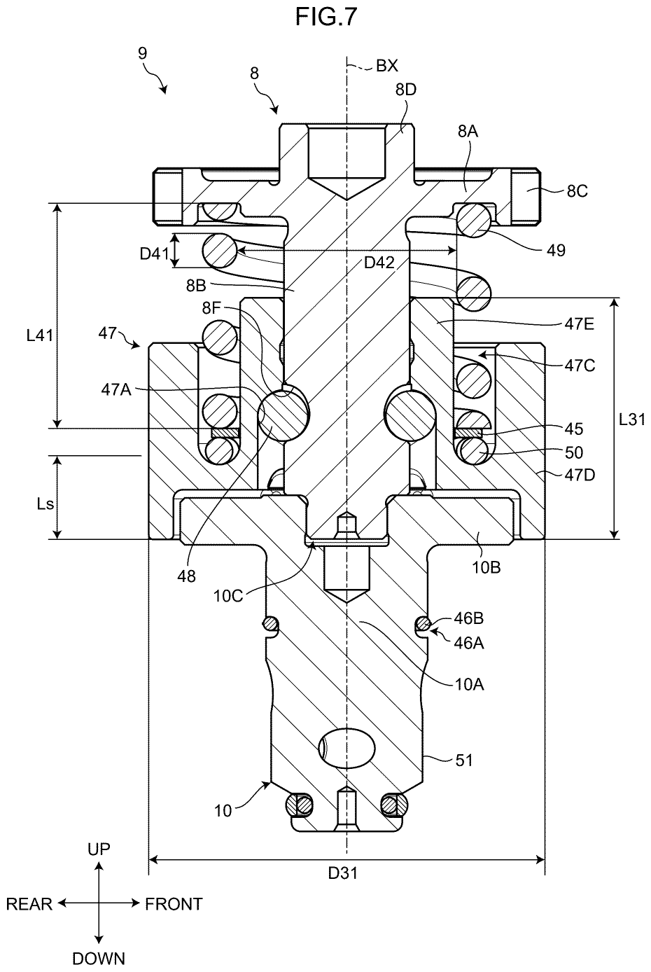

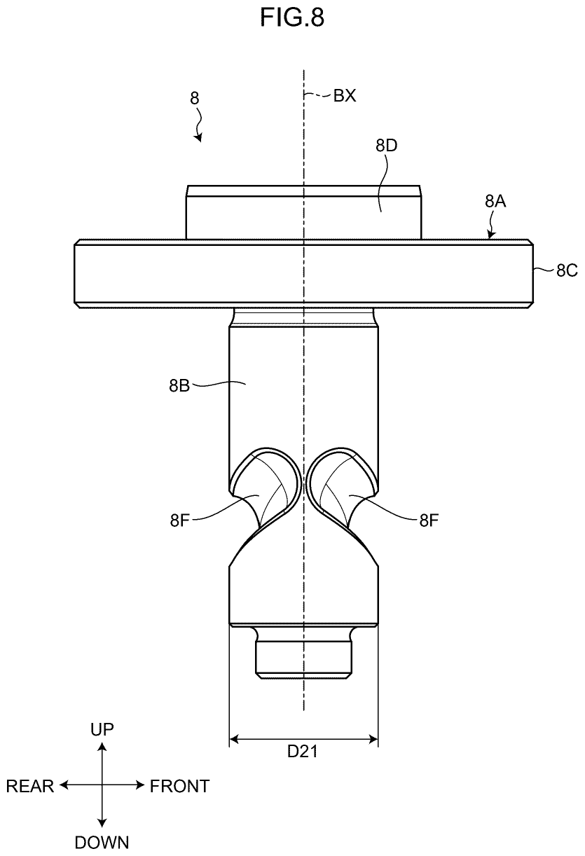

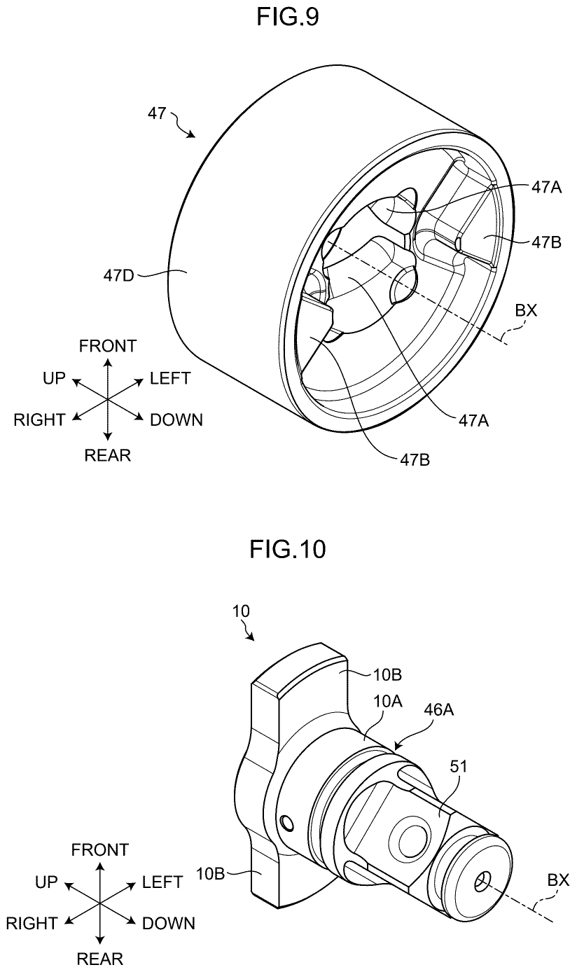

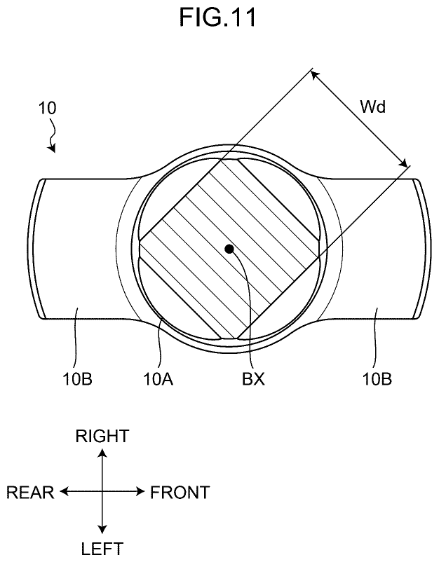

Impact mechanism Next, a detailed structure of the impact mechanism 9 will be described. FIG. 7 is a longitudinal sectional view illustrating the impact mechanism 9 according to the embodiment. FIG. 8 is a side view illustrating the spindle 8 according to the embodiment. FIG. 9 is a perspective view illustrating the hammer 47 according to the embodiment. FIG. 10 is a perspective view illustrating the anvil 10 according to the embodiment. FIG. 11 is a sectional view illustrating the tip tool holding portion 51 according to the embodiment.

As illustrated in FIG. 5, the spindle 8 is connected to the speed reduction mechanism 7. The spindle 8 is rotated by the motor 6. The spindle 8 is arranged forward of the motor 6. The spindle 8 is arranged forward of the stator 26. The spindle 8 is arranged forward of the rotor 27. The spindle 8 is arranged forward of the speed reduction mechanism 7. The spindle 8 is rotated by the rotor 27. The spindle 8 is rotated by rotational force of the rotor 27 transmitted via the speed reduction mechanism 7.

The spindle 8 extends in a direction intersecting the front-rear direction. The spindle 8 extends downward along the second rotation axis BX in the up-down direction. The spindle 8 rotates about the second rotation axis BX. The second rotation axis BX of the spindle 8 and the first rotation axis AX of the motor 6 are not parallel, and intersect each other. A direction of the second rotation axis BX of the spindle 8 may intersect the front-rear direction (that is, the first rotation axis AX) at any angle of 80 degrees or more and 100 degrees or less. In the embodiment, the second rotation axis BX is orthogonal to the front-rear direction and extends in the up-down direction. In the embodiment, the spindle 8, the hammer 47, and the anvil 10 are arranged along the second rotation axis BX and rotate about the second rotation axis BX.

As illustrated in FIG. 5 and FIG. 7, the spindle 8 includes a flange portion 8A and a spindle shaft portion 8B protruding downward from the flange portion 8A. The spindle gear 8C is provided on an outer periphery of the flange portion 8A.

The spindle 8 is rotatably supported by a spindle bearing 44. The spindle bearing 44 is held by the case 4. The spindle 8 has a cylindrical portion 8D protruding upward from the flange portion 8A. The spindle bearing 44 is arranged on an outer periphery of the cylindrical portion 8D. The spindle bearing 44 supports the outer periphery of the cylindrical portion 8D in a rotatable manner. The spindle bearing 44 is a plain bearing. A lower end portion of the spindle shaft portion 8B has a projection having a cylindrical shape and protruding downward. The lower end portion of the spindle shaft portion 8B is arranged in an anvil recess portion 10C formed in an upper surface of the anvil 10. A lower portion of the spindle 8 is rotatably supported by an anvil bearing 46 via the anvil 10.

The spindle shaft portion 8B is inserted into the inside of the hammer 47. The spindle shaft portion 8B passes through the inside of an inner cylindrical portion 47E of the hammer 47. An outer peripheral surface of the spindle shaft portion 8B faces an inner surface of the inner cylindrical portion 47E of the hammer 47 in the radial direction. As illustrated in FIG. 7 and FIG. 8, the spindle 8 has spindle grooves 8F. At least a part of each of the balls 48 is arranged in the corresponding spindle groove 8F. Each of the spindle grooves 8F is provided in a part of the outer peripheral surface of the spindle shaft portion 8B. Each of the spindle grooves 8F is inclined with respect to the second rotation axis BX.

For example, the spindle shaft portion 8B has the diameter D21 of 10 mm or more and 25 mm or less. In one example, the spindle shaft portion 8B has the diameter D21 of 11 mm or more. In another example, the spindle shaft portion 8B has the diameter D21 of 12 mm or more. In one example, the spindle shaft portion 8B has the diameter D21 of 24 mm or less. In another example, the spindle shaft portion 8B has the diameter D21 of 23 mm or less.

For example, the spindle groove 8F has a lead angle of 25 degrees or more and 40 degrees or less. Note that the lead angle of the spindle groove 8F refers to an angle between an approximated straight line obtained by developing a trajectory traced by the center of the spindle groove 8F for one rotation onto a plane and then approximating the trajectory as a straight line and the front-rear direction. In one example, the spindle groove 8F has the lead angle of 28 degrees or more. In another example, the spindle groove 8F has the lead angle of 30 degrees or more. In one example, the spindle groove 8F has the lead angle of 37 degrees or less. In another example, the spindle groove 8F has the lead angle of 35 degrees or less.

For example, the spindle 8 has weight of 60 g or more and 260 g or less. In one example, the spindle 8 has the weight of 65 g or more. In another example, the spindle 8 has the weight of 70 g or more. In one example, the spindle 8 has the weight of 250 g or less. In another example, the spindle 8 has the weight of 245 g or less.

For example, the spindle 8 has a moment of inertia of 6.0 kg·mm² or more and 45 kg·mm² or less. In one example, the spindle 8 has the moment of inertia of 6.5 kg·mm² or more. In another example, the spindle 8 has the moment of inertia of 7.0 kg·mm² or more. In one example, the spindle 8 has the moment of inertia of 42.5 kg·mm² or less. In another example, the spindle 8 has the moment of inertia of 40.0 kg·mm² or less.

As illustrated in FIG. 5, the hammer 47 is arranged forward of the speed reduction mechanism 7. The hammer 47 is rotated by the spindle 8. The hammer 47 is arranged around the spindle shaft portion 8B. The hammer 47 is held by the spindle shaft portion 8B. The balls 48 are arranged between the spindle shaft portion 8B and the hammer 47. The spring 49 is supported by each of the flange portion 8A and the hammer 47.

As illustrated in FIG. 7, the hammer 47 includes a body portion 47D, the inner cylindrical portion 47E, hammer grooves 47A, and hammer protrusion portions 47B (see FIG. 9). The body portion 47D is arranged around the spindle shaft portion 8B. The body portion 47D has an annular shape. The body portion 47D protrudes outward from a lower end of the inner cylindrical portion 47E and extends upward and downward in a cylindrical shape. The body portion 47D forms an outer peripheral surface of the hammer 47. A recess portion 47C is provided in an upper portion of the body portion 47D. The recess portion 47C is provided so as to be recessed downward from an upper end portion of the body portion 47D. The recess portion 47C has a ring shape. The recess portion 47C is positioned between the body portion 47D and the inner cylindrical portion 47E in the radial direction. The inner cylindrical portion 47E extends in a cylindrical shape in the up-down direction. The spindle shaft portion 8B is inserted into the inner cylindrical portion 47E. The hammer 47 has the hammer grooves 47A. At least a part of each of the balls 48 is located in the corresponding hammer groove 47A. Each of the hammer grooves 47A is provided in a part of the inner surface of the inner cylindrical portion 47E. The hammer protrusion portions 47B are provided on a lower surface of the body portion 47D. Two hammer protrusion portions 47B are provided. The pair of hammer protrusion portions 47B is provided so as to face each other in the radial direction with the second rotation axis BX therebetween. That is, the two hammer protrusion portions 47B are provided at an interval of 180 degrees in the rotation direction around the second rotation axis BX.

The hammer 47 is rotated by the motor 6. The rotational force of the motor 6 is transmitted to the hammer 47 via the speed reduction mechanism 7 and the spindle 8. The hammer 47 is rotatable together with the spindle 8 based on rotational force of the spindle 8 rotated by the motor 6. A rotation axis of the hammer 47 coincides with the second rotation axis BX of the spindle 8. The hammer 47 rotates about the second rotation axis BX. The hammer 47 moves with respect to the spindle 8. The hammer 47 reciprocates along the second rotation axis BX. That is, the hammer 47 moves relative to the spindle 8 in the up-down direction. The hammer 47 rotates about the second rotation axis BX while moving with respect to the spindle 8 in the up-down direction and impacts the anvil 10 in the rotation direction. The hammer protrusion portions 47B serve as contact portions when impacting the anvil 10.

In the embodiment, the weight of the hammer 47 is 135 g or more and 600 g or less. In one example, the hammer 47 has the weight of 140 g or more. In another example, the hammer 47 has the weight of 145 g or more. In yet another example, the hammer 47 has the weight of 150 g or more. In one example, the hammer 47 has the weight of 590 g or less. In another example, the hammer 47 has the weight of 580 g or less. In yet another example, the hammer 47 has the weight of 575 g or less.

In the embodiment, a moment of inertia of the hammer 47 is 40 kg·mm² or more and 500 kg·mm² or less. In one example, the hammer 47 has the moment of inertia of 42 kg·mm² or more. In another example, the hammer 47 has the moment of inertia of 44 kg·mm² or more. In yet another example, the hammer 47 has the moment of inertia of 45 kg·mm² or more. In one example, the hammer 47 has the moment of inertia of 480 kg·mm² or less. In another example, the hammer 47 has the moment of inertia of 470 kg·mm² or less. In yet another example, the hammer 47 has the moment of inertia of 460 kg·mm² or less.

In the embodiment, a diameter D31 of the hammer 47 is 43 mm or more and 80 mm or less, and a total length L31 of the hammer 47 is 26 mm or more and 45 mm or less. The diameter D31 of the hammer 47 is the maximum outer diameter of the hammer 47. The total length L31 of the hammer 47 is the maximum size in the axial direction of the hammer 47, and is a distance between a lower end and an upper end of the hammer 47. In one example, the hammer 47 has the diameter D31 of 43.2 mm or more. In another example, the hammer 47 has the diameter D31 of 43.4 mm or more. In yet another example, the hammer 47 has the diameter D31 of 43.6 mm or more. In one example, the hammer 47 has the diameter D31 of 77 mm or less. In another example, the hammer 47 has the diameter D31 of 74 mm or less. In yet another example, the hammer 47 has the diameter D31 of 71 mm or less. In one example, the hammer 47 has the total length L31 of 26.2 mm or more. In another example, the hammer 47 has the total length L31 of 26.4 mm or more. In yet another example, the hammer 47 has the total length L31 of 26.6 mm or more. In one example, the hammer 47 has the total length L31 of 43 mm or less. In another example, the hammer 47 has the total length L31 of 41 mm or less. In yet another example, the hammer 47 has the total length L31 of 39 mm or less.

The balls 48 are made of metal such as steel. The balls 48 are arranged between the spindle shaft portion 8B and the hammer 47. The balls 48 are arranged between the spindle groove 8F and the hammer grooves 47A. The balls 48 can roll inside the spindle grooves 8F and inside the hammer grooves 47A. The hammer 47 is movable as the balls 48 move. The spindle 8 and the hammer 47 can move relative to each other in both the axial direction and the rotation direction within a movable range defined by the spindle grooves 8F and the hammer grooves 47A.

The ball 48 has, for example, a diameter of 5.0 mm or more and 9.0 mm or less. In one example, the ball 48 has the diameter of 5.2 mm or more and 8.8 mm or less. In another example, the ball 48 has the diameter of 5.4 mm or more and 8.6 mm or less.

The ball 48 has weight of, for example, 0.4 g or more and 2.0 g or less. In one example, the ball 48 has the weight of 0.5 g or more and 1.8 g or less. In another example, the ball 48 has the weight of 0.6 g or more and 1.6 g or less.

The ball 48 has, for example, a moment of inertia of 2.00×10⁻³ kg·mm² or more and 8.00×10⁻³ kg·mm² or less. In one example, the ball 48 has the moment of inertia of 2.10×10⁻³ kg·mm² or more and 7.80×10⁻³ kg·mm² or less. In another example, the ball 48 has the moment of inertia of 2.15×10⁻³ kg·mm² or more and 7.60×10⁻³ kg·mm² or less.

The spring 49 generates an elastic force that moves the hammer 47 downward. The spring 49 is a compression coil spring in which a metal wire is wound in a coil shape (that is, a spiral shape). The spring 49 biases the hammer 47 toward the anvil 10. The spring 49 is arranged between the flange portion 8A and the hammer 47 in the up-down direction. A lower portion of the spring 49 is located in the ring-shaped recess portion 47C provided on an upper surface of the hammer 47. A washer 45 is provided inside the recess portion 47C. The washer 45 is supported by the body portion 47D via the balls 50. An upper end of the spring 49 is supported by the flange portion 8A. A lower end of the spring 49 is supported by the washer 45. Due to the interposition of the washer 45 and the balls 50, the hammer 47 and the spring 49 are relatively rotatable about the second rotation axis BX.

The spring 49 is assembled to the impact mechanism 9 in a state of being compressed in advance. The spring 49 applies a predetermined preload downward to the hammer 47 in a state in which the angle impact tool 1 is not in operation. In the present teachings, a length of the spring 49 (length of when the preload is generated) in a state in which the angle impact tool 1 is not in operation is referred to as a preload length.

The spring 49 has, for example, a wire diameter D41 of 3.0 mm or more and 7.5 mm or less. In one example, the spring 49 has the wire diameter D41 of 3.2 mm or more and 7.3 mm or less. In another example, the spring 49 has the wire diameter D41 of 3.4 mm or more and 7.1 mm or less. In yet another example, the spring 49 has the wire diameter D41 of 3.5 mm or more and 7.0 mm or less.

The spring 49 has, for example, a coil inner diameter D42 of 20.0 mm or more and 45.0 mm or less. In one example, the spring 49 has the coil inner diameter D42 of 21.0 mm or more and 43.0 mm or less. In another example, the spring 49 has the coil inner diameter D42 of 22.0 mm or more and 41.0 mm or less. In yet another example, the spring 49 has the coil inner diameter D42 of 23.0 mm or more and 39.0 mm or less.

The spring 49 has a preload length L41 of, for example, 20 mm or more and 52 mm or less. In one example, the spring 49 has the preload length L41 of 22 mm or more and 50 mm or less. In another example, the spring 49 has the preload length L41 of 24 mm or more and 48 mm or less. In yet another example, the spring 49 has the preload length L41 of 25 mm or more and 47 mm or less.

The spring 49 applies, for example, the preload of 250 N or more and 500 N or less to the hammer 47. In one example, the spring 49 applies the preload of 260 N or more and 480 N or less to the hammer 47. In another example, the spring 49 applies the preload of 270 N or more and 460 N or less to the hammer 47. In yet another example, the spring 49 applies the preload of 280 N or more and 440 N or less to the hammer 47.

The spring 49 has, for example, a spring constant of 30.0 N/mm or more and 75.0 N/mm or less. In one example, the spring 49 has the spring constant of 32.0 N/mm or more and 73.0 N/mm or less. In another example, the spring 49 has the spring constant of 34.0 N/mm or more and 71.0 N/mm or less. In yet another example, the spring 49 has the spring constant of 35.0 N/mm or more and 70.0 N/mm or less.

As illustrated in FIG. 7 and FIG. 10, the anvil 10 is an output portion of the angle impact tool 1. The anvil 10 is rotated by the rotational force of the motor 6. At least a part of the anvil 10 is arranged below the spindle 8. At least a part of the anvil 10 is arranged below the hammer 47. The anvil 10 is impacted in the rotation direction by the hammer 47.

The anvil 10 includes an anvil shaft portion 10A having a rod shaped and anvil protrusion portions 10B. The anvil recess portion 10C that receives a protrusion portion of the spindle shaft portion 8B is provided at an upper end of the anvil 10. The anvil protrusion portions 10B are provided at the upper end of the anvil 10. The anvil protrusion portions 10B protrude outward in the radial direction from the upper end of the anvil shaft portion 10A. The anvil shaft portion 10A passes through the anvil insertion hole 83 from the inside of the case 4 and protrudes downward to the outside of the case 4. A lower end portion of the anvil shaft portion 10A is exposed to the outside of the case 4. The tip tool holding portion 51 is arranged at the lower end of the anvil 10. The tip tool holding portion 51 protrudes downward from the lower surface of the case 4. The tip tool holding portion 51 is provided at an exposed portion of the lower end of the anvil shaft portion 10A. The tip tool holding portion 51 is rotated by the spindle 8. The tip tool holding portion 51 is rotated by the spindle 8 via the hammer 47 and the anvil 10. The tip tool holding portion 51 is integrally formed with the anvil shaft portion 10A.

In the angle impact wrench according to the embodiment, the tip tool holding portion 51 is an engagement portion having a square columnar shape, and is engaged with an engagement recess portion of a socket that is a tip tool. The socket is held in a state of being fitted to the tip tool holding portion 51.

A cross section orthogonal to the second rotation axis BX of the tip tool holding portion 51 is illustrated in FIG. 11. As illustrated in FIG. 11, the tip tool holding portion 51 has a width across flats Wd of ⅜ inches or more and ⅞ inches or less in the cross section orthogonal to the second rotation axis BX. The width across flats Wd of the tip tool holding portion 51 is a distance between two opposite sides of the tip tool holding portion 51 in the cross section, and represents a size of an engagement portion of an engageable tip tool. A sectional shape of the tip tool holding portion 51 may be a hexagonal shape or the like other than the quadrangular shape. The tip tool holding portion 51 has the width across flats Wd of, for example, ⅜ inches, ½ inches, or ¾ inches.

In the embodiment, weight of the anvil 10 is 55 g or more and 250 g or less. In one example, the anvil 10 has the weight of 58 g or more. In another example, the anvil 10 has the weight of 60 g or more. In yet another example, the anvil 10 has the weight of 62 g or more. In one example, the anvil 10 has the weight of 240 g or less. In another example, the anvil 10 has the weight of 230 g or less. In yet another example, the anvil 10 has the weight of 225 g or less.

In the embodiment, a moment of inertia of the anvil 10 is 3.60 kg·mm² or more and 30.00 kg·mm² or less. In one example, the anvil 10 has the moment of inertia of 3.80×10⁻³ kg mm² or more. In another example, the anvil 10 has the moment of inertia of 3.90×10⁻³ kg·mm² or more. In yet another example, the anvil 10 has the moment of inertia of 3.95×10⁻³ kg·mm² or more. In one example, the anvil 10 has the moment of inertia of 29.00×10⁻³ kg·mm² or less. In another example, the anvil 10 has the moment of inertia of 28.00×10−3 kg·mm² or less. In yet another example, the anvil 10 has the moment of inertia of 27.00×10−3 kg·mm² or less.

As illustrated in FIG. 5, in the embodiment, a distance L51 in the up-down direction between the lower end of the anvil 10 and the upper surface of the impact mechanism housing portion 82 is 85 mm or less. Preferably, the distance L51 is 83 mm or less. More preferably, the distance L51 is 82 mm or less. In one example, the anvil 10 has the tip tool holding portion 51 having ½ inches, and the distance L51 in the up-down direction between the lower end of the anvil 10 and the upper surface of the impact mechanism housing portion 82 is 81.0 mm. In another example, the anvil 10 has the tip tool holding portion 51 having ⅜ inches, and the distance L51 in the up-down direction between the lower end of the anvil 10 and the upper surface of the impact mechanism housing portion 82 is 78.0 mm.

In the embodiment, a distance L52 in the front-rear direction between the central axis of the anvil 10 and the front end surface of the impact mechanism housing portion 82 is 30 mm or less. In the embodiment, the central axis of the anvil 10 coincides with the second rotation axis BX. Preferably, the distance L52 is 28 mm or less. More preferably, the distance L52 is 27 mm or less. In one example, the distance L52 in the front-rear direction between the central axis of the anvil 10 and the front end surface of the impact mechanism housing portion 82 is 26.5 mm.

The anvil 10 is rotatably supported by the anvil bearing 46. The rotation axis of the anvil 10 coincides with the second rotation axis BX of the spindle 8. The anvil 10 rotates about the second rotation axis BX. The anvil bearing 46 is arranged inside the anvil insertion hole 83. The anvil bearing 46 is arranged inside the anvil insertion hole 83 of the case 4. The anvil bearing 46 is held in the anvil insertion hole 83. The anvil insertion hole 83 is arranged around the anvil shaft portion 10A. The anvil bearing 46 supports the anvil shaft portion 10A in a rotatable manner. In the embodiment, the anvil bearing 46 is a plain bearing. The anvil shaft portion 10A is provided with a groove 46A having a ring shape and facing the anvil bearing 46. A seal member 46B having a ring shape is arranged in the groove 46A. The washer 52 is provided on an inner bottom surface of the case 4. The washer 52 faces the anvil protrusion portions 10B.

The hammer protrusion portions 47B can come in contact with the anvil protrusion portions 10B. When the motor 6 is driven in a state in which the hammer protrusion portions 47B and the anvil protrusion portions 10B are in contact with each other, the anvil 10 rotates together with the hammer 47 and the spindle 8.

The anvil 10 is impacted in the rotation direction by the hammer 47. For example, when a load acting on the anvil 10 becomes high during the screw-tightening work, the anvil 10 can no longer be caused to rotate only by the power generated by the motor 6. When the anvil 10 can no longer be caused to rotate only by the power generated by the motor 6, the rotation of the anvil 10 and the hammer 47 temporarily stops. Even when the rotation of the hammer 47 temporarily stops, the rotation of the spindle 8 continues owing to the power generated by the motor 6. Thus, when the rotation of the hammer 47 has temporarily stopped and the spindle 8 continue to rotate, the balls 48 move upward while being guided by the spindle grooves 8F and the hammer grooves 47A. The hammer 47 receives a force from the balls 48 and moves upward with the balls 48. That is, while the rotation of the anvil 10 is temporarily stopped, the hammer 47 moves upward owing to the rotation of the spindle 8. When the hammer 47 moves upward, the contact between the hammer protrusion portion 47B and the anvil protrusion portions 10B is released.

The spring 49 constantly generates an elastic force that moves the hammer 47 downward. The hammer 47 that has moved upward is then moved downward by the elastic force of the spring 49. When moving downward, the hammer 47 receives a force in the rotation direction from the balls 48. That is, the hammer 47 moves downward while rotating. When the hammer 47 moves downward while rotating, the hammer protrusion portions 47B come into contact with the anvil protrusion portions 10B while rotating. This allows the anvil protrusion portions 10B to be impacted in the rotation direction by the hammer protrusion portions 47B. The power of the motor 6 and the inertial force of the hammer 47 both act on the anvil 10 at this time. Thus, the anvil 10 can rotate about the second rotation axis BX with higher torque.

While the spindle 8 is rotating by the motor 6 after the hammer starts to impact the anvil, the hammer 47 repeats, a series of movements including: backward movement (upward movement) from the anvil 10; release of the contact with the anvil 10; forward movement (downward movement) to the anvil 10; and impact on the anvil 10 (re-contact with the anvil 10). In the present teachings, as illustrated in FIG. 7, the upward/downward moving distance Ls along the second rotation axis BX of the hammer 47 is referred to as a stroke of the hammer 47.

In the embodiment, the upward/downward moving distance Ls (stroke) of the hammer 47 with respect to the spindle 8 is 8 mm or more and 16 mm or less. In one example, the hammer 47 is movable with respect to the spindle 8 with the upward/downward moving distance Ls of 8.3 mm or more. In another example, the hammer 47 is movable with respect to the spindle 8 with the upward/downward moving distance Ls of 8.6 mm or more. In yet another example, the hammer 47 is movable with respect to the spindle 8 with the upward/downward moving distance Ls of 8.9 mm or more. In one example, the hammer 47 is movable with respect to the spindle 8 with the upward/downward moving distance Ls of 15.5 mm or less. In another example, the hammer 47 is movable with respect to the spindle 8 with the upward/downward moving distance Ls of 15.0 mm or less. In yet another example, the hammer 47 is movable with respect to the spindle 8 with the upward/downward moving distance Ls of 14.5 mm or less.

In the embodiment, the number of impacts per rotation of the hammer 47 is larger than 1. In one example, the number of impacts per rotation of the hammer 47 is 1.5 or more. In another example, the number of impacts per rotation of the hammer 47 is 1.8 or more. In yet another example, the number of impacts per rotation of the hammer 47 is 2 or more.

Each time the hammer 47 impacts the anvil 10, impulsive torque acts on a tightening member engaged with the anvil 10 via the tip tool. In the screw tightening work, the tightening member is further tightened every time the impact torque acts thereon whereby the tightening torque applied to the tightening member increases with the number of impacts.

With the above configuration, the impact mechanism 9 converts the continuous torque input from the motor 6 into consecutive rotational impacts capable of generating the tightening torque of 275 Nm or more to the tightening member. Preferably, the impact mechanism 9 can generate the tightening torque of 280 Nm or more. More preferably, the impact mechanism 9 can generate the tightening torque of 290 Nm or more. More preferably, the impact mechanism 9 can generate the tightening torque of 300 Nm or more.

Although it is considered that the tightening torque by the impact converges to a certain value when the tightening work is performed for a long time, measurement is difficult. Thus, the tightening torque is defined as the maximum value (maximum tightening torque) of the tightening torque achieved in a certain measurement time. Note that the maximum tightening torque is the torque of when tightening (fastening) a member to be tightened (fastened) with the tightening member, and generally refers to the torque measured for a further tightening torque wrench or the like with respect to the member to be tightened after it has been tightened. Note that this is not a method in which the measuring is performed by loosening a nut or a bolt. Typically, maximum tightening torque is listed in catalogs of respective manufacturers.

In one example, the impact mechanism 9 can generate the tightening torque of 300 Nm or more by tightening for six seconds (that is, measurement time is six seconds.). In another example, the impact mechanism 9 can generate the tightening torque of 310 Nm or more by tightening for six seconds. In yet another example, the impact mechanism 9 can generate the tightening torque of 320 Nm or more by tightening for six seconds.

In one example, the impact mechanism 9 can generate the tightening torque of 275 Nm or more by tightening for three seconds (that is, the measurement time is three seconds). In another example, the impact mechanism 9 can generate the tightening torque of 285 Nm or more by tightening for three seconds. In yet another example, the impact mechanism 9 can generate the tightening torque of 295 Nm or more by tightening for three seconds.

In a case of screw loosening work such as a case of detaching the fixed tightening member, the torque acting on the tightening member peaks at the beginning of the rotation of the tightening member. The torque applied to the tightening member in the screw loosening work is referred to as nut busting torque. The nut busting torque is an upper limit value of the torque at which the loosening work of the tightening member is possible.

In the embodiment, the impact mechanism 9 can generate the nut busting torque of 450 Nm or more. In one example, the impact mechanism 9 can generate the nut busting torque of 460 Nm or more. In another example, the impact mechanism 9 can generate the nut busting torque of 470 Nm or more. In yet another example, the impact mechanism 9 can generate the nut busting torque of 480 Nm or more.

Table 1 shows the maximum tightening torque, the nut busting torque, and the hammer configuration in one configuration example of the embodiment. Table 1 shows one configuration example of the embodiment and a comparative example of a conventional angle impact tool1.

TABLE 1

| | Configuration | Comparative |
|---|---|---|
| | Example | Example |
| Maximum Tightening Torque [N · m] | | 270 |
| Tightening for Six Seconds | 330 | |
| Tightening for Three Seconds | 300 | |
| Nut Busting Torque | 500 | 300 |
| Moment of Inertia of Hammer | 45.9 | 39.4 |
| (kg*mm²) | | |
| Hammer Weight (g) | 154.1 | 130.4 |
| Hammer Size (mm) | φ 44.0 × 26.8 | φ 42.8 × 25.5 |

In the maximum tightening torque in Table 1, “tightening for six seconds” and “tightening for three seconds” indicate that the measurement time of the maximum tightening torque is six seconds and three seconds, respectively. In the angle impact tool 1 according to the configuration example, the maximum tightening torque in the tightening for three seconds is 300 Nm, and the maximum tightening torque in the tightening for six seconds is 330 Nm. On the other hand, the maximum tightening torque of the comparative example is 270 Nm. The maximum tightening torque of the comparative example is a catalog value, and the measurement time is unknown.

In the configuration example, the nut busting torque is 500 Nm. On the other hand, the maximum tightening torque of the comparative example is 300 Nm.

In the angle impact tool 1 according to the configuration example illustrated in Table 1, the hammer 47 has the moment of inertia of 45.9 kg·mm², the weight of 154.1 g, the diameter D31 of 44.0 mm, and the total length L31 of 26.8 mm. In contrast, the hammer of the comparative example has a moment of inertia of 39.4 kg·mm², weight of 130.4 g, a diameter of 42.8 mm, and a total length of 25.5 mm.

Table 2 shows a plurality of types of configuration examples of the angle impact tool. Table 2 shows a first configuration example, a second configuration example, and a third configuration example in which the maximum tightening torque is different.

TABLE 2

| | | First | Second | Third |
|---|---|---|---|---|
| | | Configuration | Configuration | Configuration |
| | | Example | Example | Example |
| Maximum Tightening Torque | | 300 | 600 | 800 |
| (N · m) | | | | |
| Nut Busting Torque (N · m) | | 530 | 1,000 | 1,700 |
| Width Across Flats of Tip Tool | | ⅜ | ½ | ¾ |
| Holding Portion (in) | | | | |
| Number of Times of Impact per | | 2 | 2 | 2 |
| Rotation of Hammer (Times) | | | | |
| Number of Times of Impact | | 4,000 | 2,700 | 2,200 |
| (min⁻¹) | | | | |
| Energy per Impact (J) | | 1.01 | 1.53 | 3.03 |
| Current Value (A) | | 35-40 | | |
| Spring | Wire Diameter | φ 3.8 | φ 5.0 | φ 6.5 |
| | (mm) | | | |
| | Coil Inner | φ 24.4 | φ 33.8 | φ 38.0 |
| | Diameter (mm) | | | |
| | Preload Length | 25.1 | 32.5 | 46.0 |
| | (mm) | | | |
| | Preload (N) | 343 | 290 | 428 |
| | Spring Constant | 36.3 | 52.2 | 65.8 |
| | (N/mm) | | | |
| Spindle | Diameter (mm) | φ 14.0 | φ 20.0 | φ 22.0 |
| | Lead Angel (deg) | 32.0 | 31.0 | 31.1 |
| | Weight (g) | 73.77 | 149.23 | 241.93 |
| | Moment of Inertia | 7.17 | 19.27 | 38.96 |
| | (kg*mm²) | | | |
| Ball | Diameter (mm) | φ 5.6 | φ 6.4 | φ 7.1 |
| | Weight (g) | 0.70 | 1.05 | 1.47 |
| | Moment of Inertia | 2.18E−03 | 4.23E03 | 7.40E−03 |
| | (kg*mm²) | | | |
| Hammer | Weight (g) | 154.1 | 293.0 | 570.0 |
| | Moment of Inertia | 45.91 | 153.0 | 456.0 |
| | (kg*mm²) | | | |
| | Size (φ × H) | φ 44.0 × 26.8 | φ 56.0 × 32.0 | φ 70.0 × 37.0 |
| | Stroke (mm) | 9.0 | 14.0 | 14.0 |
| Anvil | Weight (g) | 62.50 | 89.47 | 222.94 |
| | Moment of Inertia | 3.98 | 8.64 | 26.98 |
| | (kg*mm²) | | | |
| Speed | Reduction Ratio | 8.36 | 9 | 10 |
| Reduction | | | | |
| Mechanism | | | | |

### First Configuration Example

In the first configuration example, the impact mechanism 9 can generate the tightening torque of 300 Nm or more by the tightening for three seconds. Note that in the first configuration example, the impact mechanism 9 can generate the tightening torque of 330 Nm or more by the tightening for six seconds. In the first configuration example, the impact mechanism 9 can generate the nut busting torque of 530 Nm or more. The anvil 10 of the first configuration example has the tip tool holding portion 51 having the width across flats Wd of ⅜ inches. In the first configuration example, the width across flats Wd of the tip tool holding portion 51 may be ½ inches. In the first configuration example, the number of impacts per rotation of the hammer 47 is 2. In the first configuration example, the number of impacts per minute is 4000. In the first configuration example, a motor current value is 35 A or more and 40 A or less.

The spring 49 of the first configuration example has the wire diameter D41 of 3.8 mm. The spring 49 of the first configuration example has the coil inner diameter D42 of 24.4 mm. The spring 49 of the first configuration example has the preload length L41 of 25.1 mm. The spring 49 of the first configuration example applies the preload of 343 N to the hammer 47. The spring 49 of the first configuration example has the spring constant of 36.3 N/mm.

The spindle shaft portion 8B of the spindle 8 of the first configuration example has the diameter D21 of 14.0 mm. The spindle groove 8F of the spindle 8 of the first configuration example has the lead angle of 32.0 degrees. The spindle 8 of the first configuration example has the weight of 73.77 g. The spindle 8 of the first configuration example has the moment of inertia of 7.17 kg·mm².

The ball 48 of the first configuration example has the diameter of 5.6 mm. The ball 48 of the first configuration example has the weight of 0.70 g. The ball 48 of the first configuration example has the moment of inertia of 2.18×10⁻³ kg·mm².

The hammer 47 of the first configuration example has the weight of 154.1 g. The hammer 47 of the first configuration example has the moment of inertia of 45.91 kg·mm². The hammer 47 of the first configuration example has the diameter D31 of 44.0 mm and the total length L31 of 26.8 mm. The hammer 47 of the first configuration example is movable with respect to the spindle 8 for the upward/downward moving distance Ls of 9.0 mm.

The anvil 10 of the first configuration example has the weight of 62.50 g. The anvil 10 of the first configuration example has the moment of inertia of 3.98 kg mm².

In the speed reduction mechanism 7 of the first configuration example, the speed reduction ratio between the bevel gear 35 and the spindle 8 is 8.36.

### Second Configuration Example

In the second configuration example, the impact mechanism 9 can generate the tightening torque of 600 Nm or more by the tightening for three seconds. Note that in the second configuration example, the impact mechanism 9 can generate the tightening torque of 700 Nm or more by the tightening for six seconds. In the second configuration example, the impact mechanism 9 can generate the nut busting torque of 1000 Nm or more. The anvil 10 of the second configuration example has the tip tool holding portion 51 having the width across flats Wd of ½ inches. In the second configuration example, the number of impacts per rotation of the hammer 47 is 2. In the second configuration example, the number of impacts per minute is 2700.

The spring 49 of the second configuration example has the wire diameter D41 of 5.0 mm. The spring 49 of the second configuration example has the coil inner diameter D42 of 33.8 mm. The spring 49 of the second configuration example has the preload length L41 of 32.5 mm. The spring 49 of the second configuration example applies the preload of 290 N to the hammer 47. The spring 49 of the second configuration example has the spring constant of 52.2 N/mm.

The spindle shaft portion 8B of the spindle 8 of the second configuration example has the diameter D21 of 20.0 mm. The spindle groove 8F of the spindle 8 of the second configuration example has the lead angle of 31.0 degrees. The spindle 8 of the second configuration example has the weight of 149.23 g. The spindle 8 of the second configuration example has the moment of inertia of 19.27 kg·mm².

The ball 48 of the second configuration example has the diameter of 6.4 mm. The ball 48 of the second configuration example has the weight of 1.05 g. The ball 48 of the second configuration example has the moment of inertia of 4.23×10⁻³ kg·mm².

The hammer 47 of the second configuration example has the weight of 293.0 g. The hammer 47 of the second configuration example has the moment of inertia of 153.0 kg·mm². The hammer 47 of the second configuration example has the diameter D31 of 56.0 mm and the total length L31 of 32.0 mm. The hammer 47 of the second configuration example is movable with respect to the spindle 8 for the upward/downward moving distance Ls of 14.0 mm.

The anvil 10 of the second configuration example has the weight of 89.47 g. The anvil 10 of the second configuration example has the moment of inertia of 8.64 kg·mm².

In the speed reduction mechanism 7 of the second configuration example, the reduction ratio between the bevel gear 35 and the spindle 8 is 9.

### Third Configuration Example

In the third configuration example, the impact mechanism 9 can generate the tightening torque of 800 Nm or more by the tightening for three seconds. Note that in the third configuration example, the impact mechanism 9 can generate the tightening torque of 1200 Nm or more by the tightening for six seconds. In the third configuration example, the impact mechanism 9 can generate the nut busting torque of 1700 Nm or more. The anvil 10 of the third configuration example has the tip tool holding portion 51 having the width across flats Wd of ¾ inches. In the third configuration example, the number of impacts per rotation of the hammer 47 is 2. In the third configuration example, the number of impacts per minute is 2200.

The spring 49 of the third configuration example has the wire diameter D41 of 6.5 mm. The spring 49 of the third configuration example has the coil inner diameter D42 of 38.0 mm. The spring 49 of the third configuration example has the preload length L41 of 46.0 mm. The spring 49 of the third configuration example applies the preload of 428 N to the hammer 47. The spring 49 of the third configuration example has the spring constant of 65.8 N/mm.

The spindle shaft portion 8B of the spindle 8 of the third configuration example has the diameter D21 of 22.0 mm. The spindle groove 8F of the spindle 8 of the third configuration example has the lead angle of 31.1 degrees. The spindle 8 of the third configuration example has the weight of 241.93 g. The spindle 8 of the third configuration example has the moment of inertia of 38.96 kg·mm².

The ball 48 of the third configuration example has the diameter of 7.1 mm. The ball 48 of the third configuration example has the weight of 1.47 g. The ball 48 of the third configuration example has the moment of inertia of 7.40×10⁻³ kg·mm².

The hammer 47 of the third configuration example has the weight of 570.0 g. The hammer 47 of the third configuration example has the moment of inertia of 456.0 kg·mm². The hammer 47 of the third configuration example has the diameter D31 of 70.0 mm and the total length L31 of 37.0 mm. The hammer 47 of the third configuration example is movable with respect to the spindle 8 for the upward/downward moving distance Ls of 14.0 mm.

The anvil 10 of the third configuration example has the weight of 222.94 g. The anvil 10 of the third configuration example has the moment of inertia of 26.98 kg·mm².

In the speed reduction mechanism 7 of the third configuration example, the reduction ratio between the bevel gear 35 and the spindle 8 is 10.

### Effects

As described above, in the embodiment, the angle impact tool 1 includes: the housing 2 including the grip portion 22 extending in the front-rear direction, the motor housing portion 21 arranged forward of the grip portion 22, and the battery holding portion 23 arranged rearward of the grip portion 22 and detachably holding the battery pack 25; the motor 6 arranged inside the motor housing portion 21 and including the rotor 27 that is rotatable about the first rotation axis AX extending in the front-rear direction by the electric power supplied from the battery pack 25; and the impact mechanism 9 that converts the continuous torque input from the motor 6 into the consecutive rotational impacts capable of generating the tightening torque of 275 Nm or more to the tightening member. The impact mechanism 9 includes: the spindle 8 extending along the second rotation axis BX extending in the up-down direction; the anvil 10 arranged below the spindle 8 and including, at a lower end thereof, the tip tool holding portion 51 having the width across flats Wd of ⅜ inch or more and ⅞ inch or less in the cross section orthogonal to the second rotation axis BX; the hammer 47 that is rotatable about the second rotation axis BX while moving with respect to the spindle 8 in the up-down direction and impacts the anvil 10 in the rotation direction; and the spring 49 that biases the hammer 47 toward the anvil 10.

In the above configuration, in the angle impact tool 1, which has a structure including: the grip portion 22 extending in the front-rear direction; the motor housing portion 21 arranged forward of the grip portion 22; and the battery holding portion 23 arranged rearward of the grip portion 22 and detachably holding the battery pack 25, and to which the tip tool of ⅜ inches or more and ⅞ inches or less is attached, it is possible to generate the tightening torque of 275 Nm or more to the tightening member. Thus, the tightening torque of the angle impact tool 1 can be improved.

In the embodiment, the weight of the hammer 47 is 135 g or more and 600 g or less.

In the above configuration, it is possible to improve the impact force of the hammer 47, and to achieve the high tightening torque even in the angle impact tool 1.

In the embodiment, the number of impacts per rotation of the hammer 47 is larger than 1.

In the above configuration, it is possible to increase the number of impacts of the hammer 47, and to achieve the high tightening torque in a short time even in the angle impact tool 1.

In the embodiment, the moment of inertia of the hammer 47 is 40 kg·mm² or more and 500 kg·mm² or less.

In the above configuration, it is possible to improve the impact force of the hammer 47, and to achieve the high tightening torque even in the angle impact tool 1.

In the embodiment, the diameter D31 of the hammer 47 is 43 mm or more and 80 mm or less. The total length L31 of the hammer 47 is 26 mm or more and 45 mm or less.

In the above configuration, in the angle impact tool 1, it is possible to prevent an increase in size of the impact mechanism 9, and convenience in work in a narrow place is improved.

In the embodiment, the impact mechanism 9 includes the balls 48 that is arranged between the spindle 8 and the hammer 47 and that move the hammer 47 in the rotation direction and the up-down direction as the spindle 8 rotates. The upward/downward moving distance Ls of the hammer 47 with respect to the spindle 8 is 8 mm or more and 16 mm or less.

In the above configuration, even in a case where the high tightening torque is achieved, it is possible to prevent an increase in the upward/downward moving distance Ls of the hammer 47. As a result, since the size in the up-down direction of the impact mechanism 9 is shortened, convenience in the work in the narrow place is improved.

In the embodiment, the impact mechanism 9 is capable of generating the tightening torque of 300 Nm or more.

In the above configuration, the higher tightening torque is achieved even in the angle impact tool 1.

In the embodiment, the impact mechanism 9 is capable of generating the nut busting torque of 450 Nm or more. Note that the nut busting torque is torque applied to the tightening member when the tightening member in the tightened state is loosened.

In the above configuration, it is possible to achieve the high nut busting torque required when loosening the tightening member firmly fixed by rust or the like.

In the embodiment, the weight of the anvil 10 is 55 g or more and 250 g or less.

In the above configuration, the high tightening torque can be achieved even in the angle impact tool 1.

In the embodiment, the moment of inertia of the anvil 10 is 3.60 kg·mm² or more and 30.00 kg·mm² or less.

In the above configuration, the high tightening torque can be achieved even in the angle impact tool 1.

In the embodiment, the angle impact tool 1 includes the case 4 arranged forward of the motor housing portion 21 and including the impact mechanism housing portion 82 that houses the impact mechanism 9 while protruding the tip tool holding portion 51 downward. The distance L51 in the up-down direction between the lower end of the anvil 10 and the upper surface of the impact mechanism housing portion 82 is 85 mm or less.

In the above configuration, since the size in the up-down direction of the portion that performs the tightening work is shortened, convenience in work in the narrow place is improved.

In the embodiment, the distance L52 in the front-rear direction between the central axis of the anvil 10 and the front end surface of the impact mechanism housing portion 82 is 30 mm or less.

In the above configuration, the distance in the front-rear direction from the front end surface of the impact mechanism housing portion 82 is shortened. This improves convenience of when the angle impact tool 1 is inserted into the narrow place for work.

In the embodiment, the rotor 27 includes the rotor shaft portion 33 extending in the front-rear direction. The angle impact tool 1 further includes: the bevel gear 35 provided on the rotor shaft portion 33; and the speed reduction mechanism 7 that is connected to the bevel gear 35, reduces the rotation of the bevel gear 35, and transmits the rotation to the spindle 8.

In the above configuration, the rotation of the motor 6 is reduced by the speed reduction mechanism 7, whereby the torque necessary for rotating the spindle 8 can be acquired without an increase in the size of the motor 6.

In the embodiment, the speed reduction mechanism 7 includes: the first speed reduction portion 41 that is connected to the bevel gear 35 and that rotate to reduce the rotation of the bevel gear 35; and the second speed reduction portion 42 that reduces the rotation of the first speed reduction portion 41 and transmits the rotation to the spindle 8.

In the above configuration, a multi-stage speed reduction can be performed in the process of transmitting the rotation to the spindle 8. Thus, the high reduction ratio can be achieved.

In the embodiment, the battery holding portion 23 includes, on the lower surface of the battery holding portion 23, the battery mounting portion 13 onto which the battery pack 25 is mountable.

In the above configuration, since the battery pack 25 is mounted on the lower surface of the battery holding portion 23, even a large battery pack 25 can be mounted without the increase in the size of the housing 2.

In the embodiment, the angle impact tool 1 further includes the trigger lever 14 provided on the lower surface of the grip portion 22 and operated to start the motor 6.

In the above configuration, the operability of the angle impact tool 1 is improved.

In the embodiment, the angle impact tool 1 includes: the motor 6 including the rotor 27 that is rotatable about the first rotation axis AX extending in the front-rear direction and the stator 26 to rotate the rotor 27; the motor housing portion 21 that houses the motor 6; the grip portion 22 that is arranged rearward of the motor housing portion 21; the battery holding portion 23 that is arranged rearward of the grip portion 22 and detachably holds the battery pack 25 for supplying the electric power to the motor 6; the spindle 8 that is rotated by the rotor 27 and extends along the second rotation axis BX extending in the up-down direction; the hammer 47 that is rotated by the spindle 8; and the anvil 10 that is arranged below the hammer 47 and includes, at the lower end thereof, the tip tool holding portion 51 having the width across flats Wd of ⅜ inches or more and ⅞ inches or less in the cross section orthogonal to the second rotation axis BX. The maximum tightening torque of the anvil 10 is 275 Nm or more.

In the above configuration, in the structure including the motor housing portion 21, the grip portion 22 arranged behind the motor housing portion 21, and the battery holding portion 23 arranged behind the grip portion 22 and detachably holding the battery pack 25, the maximum tightening torque of 275 Nm or more can be generated in the angle impact tool 1 to which the tip tool of ⅜ inches or more and ⅞ inches or less is mounted. Thus, the tightening torque of the angle impact tool 1 can be improved.

### Other Embodiments

In the above-described embodiment, each of the numerical values shown by each of the configuration example is an example, and is not a limitation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An angle impact tool comprising:
a housing including a grip portion extending in a front-rear direction, a motor housing portion arranged forward of the grip portion, and a battery holding portion arranged rearward of the grip portion and detachably holding a battery pack;
a motor arranged inside the motor housing portion and having a rotor that is rotatable about a first rotation axis extending in the front-rear direction by electric power supplied from the battery pack; and
an impact mechanism that converts a continuous torque input from the motor into consecutive rotational impacts capable of generating tightening torque of 275 Nm or more to a tightening member, wherein
the impact mechanism includes
a spindle extending along a second rotation axis extending in an up-down direction,
an anvil arranged below the spindle and including, at a lower end thereof, a tip tool holding portion having a width across flats of ⅜ inches or more and ⅞ inches or less in a cross section orthogonal to the second rotation axis,
a hammer that is rotatable about the second rotation axis while moving with respect to the spindle in the up-down direction and impacts the anvil in a rotation direction, and
a spring that biases the hammer toward the anvil.

2. The angle impact tool according to claim 1, wherein
weight of the hammer is 135 g or more and 600 g or less.

3. The angle impact tool according to claim 1, wherein
the number of impacts per rotation of the hammer is larger than 1.

4. The angle impact tool according to claim 1, wherein
a moment of inertia of the hammer is 40 kg·mm² or more and 500 kg·mm² or less.

5. The angle impact tool according to claim 1, wherein
a diameter of the hammer is 43 mm or more and 80 mm or less, and
a total length of the hammer is 26 mm or more and 45 mm or less.

6. The angle impact tool according to claim 1, wherein
the impact mechanism includes a ball that is arranged between the spindle and the hammer and that moves the hammer in the rotation direction and the up-down direction as the spindle rotates, and
an upward/downward moving distance of the hammer with respect to the spindle is 8 mm or more and 16 mm or less.

7. The angle impact tool according to claim 1, wherein
the impact mechanism is capable of generating the tightening torque of 300 Nm or more.

8. The angle impact tool according to claim 1, wherein
the impact mechanism is capable of generating nut busting torque of 450 Nm or more.

9. The angle impact tool according to claim 1, wherein
weight of the anvil is 55 g or more and 250 g or less.

10. The angle impact tool according to claim 1, wherein
a moment of inertia of the anvil is 3.60 kg·mm² or more and 30.00 kg·mm² or less.

11. The angle impact tool according to claim 1, further comprising
a case arranged forward of the motor housing portion and including an impact mechanism housing portion that houses the impact mechanism while protruding the tip tool holding portion downward, wherein
a distance in the up-down direction between a lower end of the anvil and an upper surface of the impact mechanism housing portion is 85 mm or less.

12. The angle impact tool according to claim 11, wherein
a distance in the front-rear direction between a central axis of the anvil and a front end surface of the impact mechanism housing portion is 30 mm or less.

13. The angle impact tool according to claim 1, wherein
the rotor includes a rotor shaft portion extending in the front-rear direction,
the angle impact tool further comprises:
a bevel gear provided on the rotor shaft portion; and
a speed reduction mechanism that is connected to the bevel gear, reduces a rotation of the bevel gear, and transmits the rotation to the spindle.

14. The angle impact tool according to claim 13, wherein
the speed reduction mechanism includes:
a first speed reduction portion that is connected to the bevel gear and rotates to reduce the rotation of the bevel gear; and
a second speed reduction portion that reduces a rotation of the first speed reduction portion and transmits the rotation to the spindle.

15. The angle impact tool according to claim 1, wherein
the battery holding portion includes, on a lower surface of the battery holding portion, a battery mounting portion onto which the battery pack is mountable.

16. The angle impact tool according to claim 1, further comprising
a trigger lever provided on a lower surface of the grip portion and operated to start the motor.

17. An angle impact tool comprising:
a motor including a rotor that is rotatable about a first rotation axis extending in a front-rear direction and a stator to rotate the rotor;
a motor housing portion that houses the motor;
a grip portion that is arranged rearward of the motor housing portion;
a battery holding portion that is arranged rearward of the grip portion and detachably holds a battery pack for supplying electric power to the motor;
a spindle that is rotated by the rotor and extends along a second rotation axis extending in an up-down direction;
a hammer that is rotated by the spindle; and
an anvil that is arranged below the hammer and includes, at a lower end thereof, a tip tool holding portion having a width across flats of ⅜ inches or more and ⅞ inches or less in a cross section orthogonal to the second rotation axis, wherein
maximum tightening torque of the anvil is 275 Nm or more.
